(19) United States
(12) Patent Application Publication
(10) Pub. No.: US 2009/0174551 A1
(43) Pub. Date: Jul. 9, 2009

(54) Internet activity evaluation system

(76) Inventors: William Vincent Quinn, Crofton, MD (US); Christopher Joseph Clark, North Potomac, MD (US); Robert William Pearson, Rockville, MD (US); Andrey Sergeevich Mikhalchuk, Germantown, MD (US)

Correspondence Address: Thomas N. Giaccherini, Post Office Box 1146, Carmel Valley, CA, 93924, US

(21) Appl. No.: 12/008,099

(22) Filed: Jan. 7, 2008

(51) Int. Cl. G08B 21/00; G06F 15/16; H04L 9/32; G06Q 30/00

(52) U.S. Cl. 340/540; 709/224; 726/1; 705/1

(57) ABSTRACT

Methods and apparatus for evaluating Internet activity are disclosed. One embodiment of the invention pertains to a child using the Internet and a parent inspecting said child's activity on the Internet, which enables said parent to intervene if said child's Internet activity is inappropriate.

### FEDERALLY SPONSORED RESEARCH OR DEVELOPMENT

None.

### FIELD OF THE INVENTION

The present invention pertains to methods and apparatus for evaluating Internet activity. More particularly, one specific embodiment of the invention pertains to a child using the Internet and a parent inspecting said child's activity on the Internet, which enables said parent to intervene if said child's Internet activity is inappropriate.

### BACKGROUND OF THE INVENTION

Internet usage is prolific. Most children today are on the Internet in some form or fashion (e.g., web browsing, email, instant message, chat rooms, social networking, etc.). Internetworldstats.com reports Internet usage by world region. Asia leads the world with 437 million Internet users. Europe has 322 million users. North America has 110 million users. Africa, the Middle East, and Australia proper have 73 million users.

The Internet can be a wonderful resource for kids. They can use it to research school reports, communicate with teachers and other kids, and play interactive games. Any child who is old enough to punch in a few letters on the keyboard can literally access the world.

But that access can also pose hazards to children. For example, an 8-year-old might log on to a search engine and type in the word “Lego.” But with just one missed keystroke, he or she might enter the word “Legs” instead, and be directed to thousands of websites with a focus on legs—some of which may contain pornographic material.

That's why it's important for parents to be aware of what their children see and hear on the Internet, who they meet, and what they share about themselves online.

Just like any safety issue, it's a good idea for parents to talk with their kids about the parents' concerns, to take advantage of resources to protect their children from potential dangers, and to keep a close eye on their activities.

Most parents do not believe in blind trust when it comes to making sure their kids are using the Internet safely, suggests a study performed by the Kaiser Family Foundation. According to the Kaiser study, about three out of four parents check what websites their children have visited, and even more monitor how their kids use and interact with Instant Messaging and sites such as MySpace. Two-thirds of parents say they're very concerned kids see too much inappropriate content in the media overall. Concerns about Internet safety are confirmed by surveys by the Pew Internet and American Life Project. Some surveys show that over half of kids say they've been approached suggestively online, “and three out of four don't tell their parents,” said David Walsh, president of the National Institute on Media and the Family in Minneapolis. “And we've heard from kids that there are multiple MySpace pages: ‘One for my parents, and one for me.’”

There is no system today that enables patents to inspect (either as it happens or in a record and playback mode) all of the Internet activity of their children. Furthermore, there is no system today that summarizes on behalf of the parents the Internet activity of their children—a summary that is subjectively developed by the parents to flag content they consider to be inappropriate (parents have different thresholds for evaluating and judging Internet activity). The development of such a system would offer immense benefits and satisfy a long felt need by parents, and would constitute an advance in the field of Internet activity monitoring.

### SUMMARY OF THE INVENTION

The present invention comprises methods and apparatus for enabling a person to inspect Internet activity of another person for the purpose of determining the appropriateness of the Internet activity. In one particular embodiment of the invention, a teenager is using the Internet. The teenager is viewing Internet content on his home computer, which is connected to the Internet through a modem. Between the modem and computer, there is a hardware device, called a Filter, installed. The Filter was installed by the mother; the mother set up a criteria on the Filter to judge what she considered as inappropriate Internet content. The teenager views pornography. Meanwhile, the mother of the teenager is at work. While at work, the mother is alerted by the Filter that the son is viewing pornography. Two-thirds of parents say they're very concerned kids see too much inappropriate content in the media overall. Many parents want to know when their kids view inappropriate content on the Internet and what they actually saw. Parents will respond to this information in different ways. Some will confront their children; some will not confront them but will take it into consideration as they try to guide them. Nevertheless, most parents want to know. The present invention enables parents to know.

### A BRIEF DESCRIPTION OF THE DRAWINGS

FIGS. 1A and 1B illustrate one embodiment of the present invention with a mother at work receiving an alert regarding the Internet activity of her son who is at home.

FIG. 2 shows renderings of common Information Appliances.

FIG. 3 shows a person receiving an alert on a computer.

FIG. 4 shows a person receiving an alert on a PDA.

FIG. 5 shows a person receiving an alert on a cell phone.

FIG. 6 shows one embodiment of a Filter as a hardware device and shows the back of the device.

FIG. 7 shows a typical network configuration from a single computer to the Internet.

FIG. 8 shows a typical network configuration for more than one computer to the Internet.

FIG. 9 shows a typical network configuration for more than one computer to the Internet with one addition—a Filter is added.

FIG. 10 shows a Filter and a networking device combined into one hardware unit.

FIG. 11 shows a Filter and a router are combined into one hardware unit.

FIGS. 12A and 12B shows a Filter, a router and a modem combined into one hardware unit and a Filter and a networking switch combined into on hardware unit.

FIGS. 13A, 13B and 13C show one embodiment of a functional diagram of a Filter.

FIG. 14 shows one embodiment of the installation directions for a Filter.

FIG. 15 shows one embodiment of a user interface of a Filter.

FIG. 16 shows a panorama of a representation of all the web sites visited by a person using the Internet.

FIG. 17 shows a person on an information appliance establishing criteria to judge the appropriateness of Internet activity.

FIG. 18 shows a person receiving an alert regarding the web mail activity of another person.

FIG. 19 shows a Filter monitoring encrypted traffic.

FIG. 20 shows a person viewing an Index, which summarizes Internet activity where the Index is presented in the form of an automobile traffic stop-light.

FIG. 21 shows a person viewing an Index, which summarizes Internet activity where the Index is presented in the form of an automobile speedometer stop-light.

FIG. 22 shows a person viewing an Index, which summarizes Internet activity where the Index is presented in the form of a graphing function.

FIG. 23 shows a person simultaneously viewing indices, which summarize Internet activity for a plurality of Internet users.

FIG. 24 shows a person receiving Internet activity reports from an ISP.

FIG. 25 shows a person receiving Internet activity reports from a telecommunications carrier.

FIG. 26 a Filter monitoring anonymous traffic.

FIG. 27 shows a Filter reading Internet Activity on device equipped with protocol tunneling.

FIGS. 28A and 28B show a Filter monitoring and controlling the transmission of protocols and computer game usage.

FIG. 29 shows an advertiser paying for aggregated Internet activity.

FIG. 30 illustrates a Filter working without the monitored computer containing any software to assist the Filter.

FIG. 31 shows a person having no knowledge that his Internet activity is being monitored.

FIG. 32 shows a person who accomplishes the installation of a Filter without having any computer expertise.

FIG. 33 shows a Filter working which does not require configuration.

FIG. 34 shows a Filter working with a networking device, which requires no configuration for a Filter to work.

FIG. 35 shows an end-to-end environment where a Filter can work without software being loaded on any element within the environment.

FIG. 36 shows a Filter working regardless of what operating system is running on the monitored device.

FIG. 37 shows a Filter monitoring the Internet activity regarding a closed system device, such as a refrigerator.

FIG. 38 shows a Filter monitoring the Internet activity regarding a web enabled television.

FIG. 39 shows a Filter equipped with a method to bypass and a device equipped with a method to anti-bypass the Filter from monitoring it.

FIG. 40 shows a person monetizing their internet activity instead of the marketplace monetizing it.

FIG. 41 shows households monetizing their internet activity instead of the marketplace monetizing it.

FIG. 42 shows a method for providing anonymous internet transactions to internet users.

### A DETAILED DESCRIPTION OF PREFERRED & ALTERNATIVE EMBODIMENTS

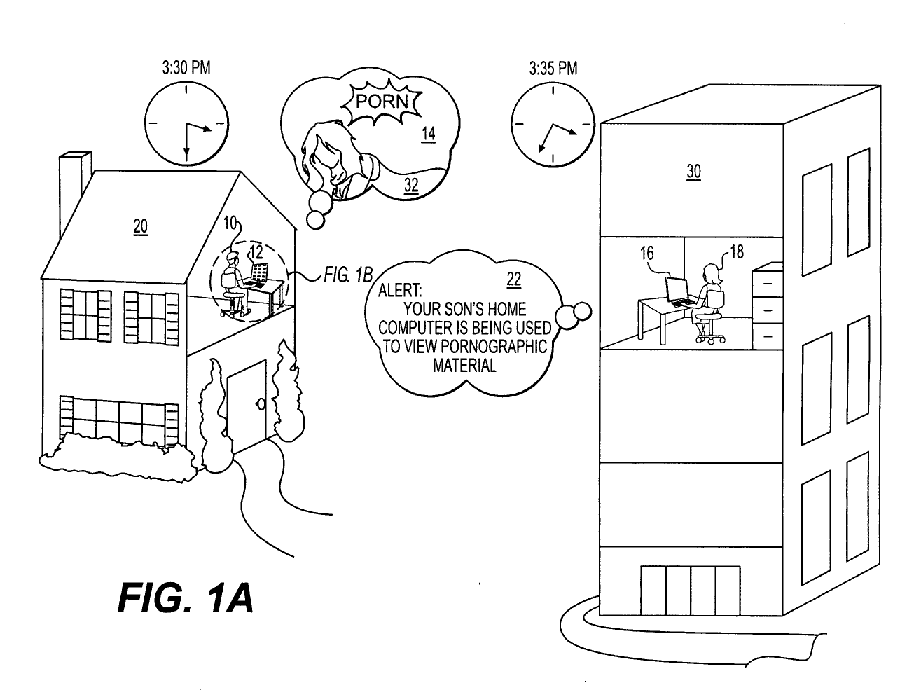

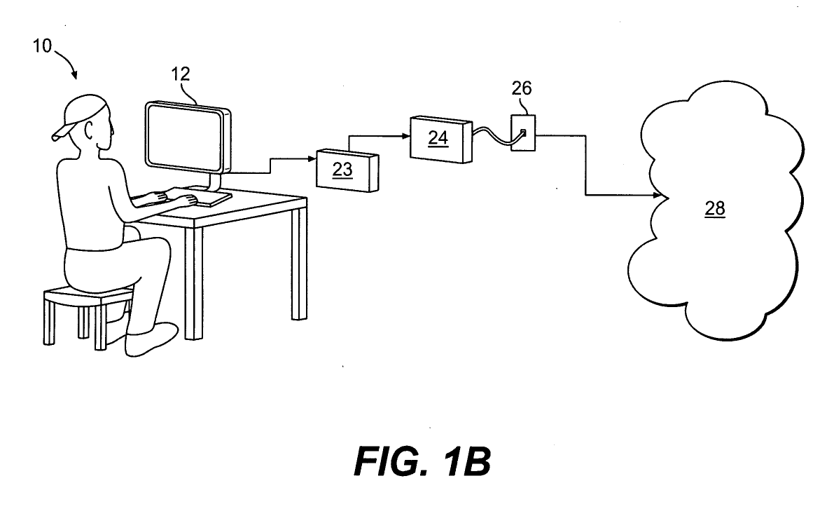

FIGS. 1A and 1B illustrate one embodiment of the present invention. In FIG. 1A, a First Person 10, such as a teenage boy, is sitting at home 20 using a First Person's Information Appliance 12. In this embodiment, the Information Appliance 12 is a computer. First Person 10 is using an Information Appliance 12 for Internet Activity 14. Specifically, he is viewing pornography. While at her place of work 30, a Second Person 18, the boy's mother, receives an Alert 22 on a Second Person's Information Appliance 16. Alert 22 reads: “Your son's home computer is being used to view pornographic material.” Second Person 18 judges this Internet Activity 14 as inappropriate 32. Second Person 18 wishes to monitor her son's Internet Activity 14 so she is able to intervene or apply some parenting method. The mother is able to receive said Alert 22 because of the installation of a Filter 23 in the network at home 20. Home networks typically must have a Networking Device 24 of some sort to enable a connection to an Internet 28. Filter 23 is connected between a First Person's Information Appliance 12 and a wall jack 26, which is the connection leading to an Internet 28.

Most parents do not believe in blind trust when it comes to making sure their kids are using an Internet 28 safely, suggests a study performed by the Kaiser Family Foundation. According to the Kaiser study, about three out of four parents check what websites their children have visited, and even more monitor how their kids use and interact with Instant Messaging and sites such as MySpace. Two-thirds of the parents say they're very concerned kids see too much inappropriate content in the media overall. Concerns about Internet 28 safety are confirmed by surveys by the Pew Internet and American Life Project. Some surveys show that over half of kids say they've been approached suggestively online, “and three out of four don't tell their parents,” said David Walsh, president of the National Institute on Media and the Family in Minneapolis. “And we've heard from kids that there are multiple MySpace pages: ‘One for my parents, and one for me.’”

Parents want to know what their children view on an Internet 28 and what influence it is having on them. Many technologies block content from an Internet 28. These “block” oriented technologies are easily circumvented and impracticable. Homework from school often demands use of an Internet 28. Advertisements, sometimes containing inappropriate material 32, can be found all over an Internet 28. These advertisements cannot be blocked with certainty all of the time. For example, a scantily dressed woman showed up on an advertisement that was present on a biology web site, a site used by middle school kids to assist with biology homework. Furthermore, as kids get older American culture demands that they “stay connected.” They will utilize instant messaging, email, and chat rooms. If there was a technology available to enable parents to view all of their kids' Internet Activity 14 of their kids, parents would not have the time to review all of it. What is needed is an invention that sees all Internet Activity 14 and reduces that Internet Activity 14 down to the subset of activity or information that a parent feels it needs to see. If a parent judges that a subset of Internet Activity 14 is inappropriate 32 for its child, then a parent wants and needs to see that subset of inappropriate Internet Activity 32. Parents cannot block their kids from eventually seeing inappropriate Internet Activity 32. However, if parents are made aware of when and what kind of inappropriate Internet Activity 14 is seen, they can intervene according to their own timeline, parenting philosophy, and parenting style when said inappropriate Internet Activity 32 is viewed by their child.

A parent is a type of Second Person 18 who has moral and legal purview over a child, a type of First Person 10. There are other Second Person 18 and First Person 10 relationships besides a parent and child, where said Second Person 18 needs or wants to monitor Internet Activity 14 of said First Person 10.

In FIGS. 1A and 1B, the boy, either intentionally or unintentionally, views pornographic material on an Internet 28. At 3:35 PM while at work, a mom 18 is alerted that inappropriate material 32, in this embodiment pornographic material, is being transmitted on a home computer, or specifically her son's computer. The mom sees the information coming into her home, finds that it is inappropriate 32, and has the opportunity to intervene according to her own timeline, parenting philosophy, and parenting style.

In this Specification and in the Claims that follow, the term “Internet” 28 means all of the concepts described in its definition by the web site www.WhatIs.com, which is an on-line information technology dictionary of definitions, computer terms, tutorials, blogs and cheat sheets covering the latest technology trends. WhatIs.com defined “Internet” 28 as:

“The Internet, sometimes called simply “the Net,” is a worldwide system of computer networks—a network of networks in which users at any one computer can, if they have permission, get information from any other computer (and sometimes talk directly to users at other computers). It was conceived by the Advanced Research Projects Agency (ARPA) of the U.S. government in 1969 and was first known as the ARPANET. The original aim was to create a network that would allow users of a research computer at one university to be able to “talk to” research computers at other universities. A side benefit of ARPANet's design was that, because messages could be routed or rerouted in more than one direction, the network could continue to function even if parts of it were destroyed in the event of a military attack or other disaster.

Today, the Internet is a public, cooperative, and self-sustaining facility accessible to hundreds of millions of people worldwide. Physically, the Internet uses a portion of the total resources of the currently existing public telecommunication networks. Technically, what distinguishes the Internet is its use of a set of protocols called TCP/IP (for Transmission Control Protocol/Internet Protocol). Two recent adaptations of Internet technology, the intranet and the extranet, also make use of the TCP/IP protocol.

For many Internet users, electronic mail (e-mail) has practically replaced the Postal Service for short written transactions. Electronic mail is the most widely used application on the Net. You can also carry on live “conversations” with other computer users, using Internet Relay Chat (IRC). More recently, Internet telephony hardware and software allows real-time voice conversations.

The most widely used part of the Internet is the World Wide Web (often abbreviated “WWW” or called “the Web”). Its outstanding feature is hypertext, a method of instant cross-referencing. In most Web sites, certain words or phrases appear in text of a different color than the rest; often this text is also underlined. When you select one of these words or phrases, you will be transferred to the site or page that is relevant to this word or phrase. Sometimes there are buttons, images, or portions of images that are “clickable.” If you move the pointer over a spot on a Web site and the pointer changes into a hand, this indicates that you can click and be transferred to another site.

Using the Web, you have access to millions of pages of information. Web browsing is done with a Web browser, the most popular of which are Microsoft Internet Explorer and Netscape Navigator. The appearance of a particular Web site may vary slightly depending on the browser you use. Also, later versions of a particular browser are able to render more “bells and whistles” such as animation, virtual reality, sound, and music files, than earlier versions.”

In this Specification and in the Claims that follow, the term “Internet Activity” 14 means any information transmitted back and forth using an Internet 28. Examples of Internet Activity 14 include: email, instant messaging, viewing web pages, using social networking web sites, using voice over IP (VOIP), using Internet enabled video games, web mail, using proxy servers, and using protocol tunneling.

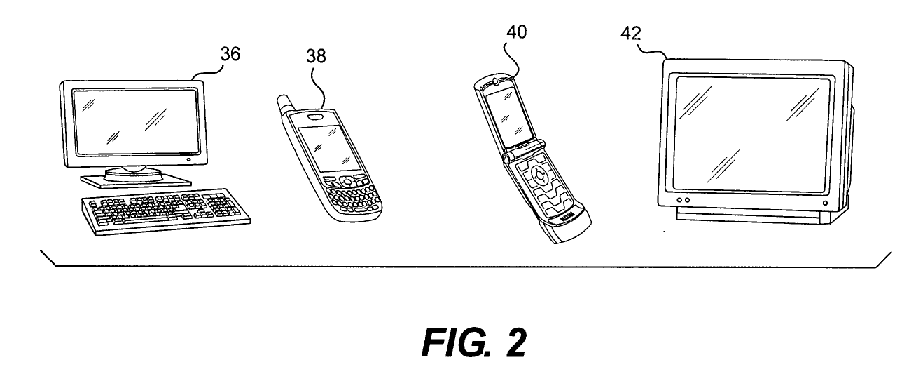

In this Specification and in the Claims that follow, the term “information appliance” means any hardware device that has physical dimension and sends and receives information to and from an Internet 28. Examples of information appliances are: phones, cell phones, PDAs, computers, and Internet enabled appliances such as a refrigerator. FIG. 2 shows renderings of common Information Appliances, which include a computer 36, a personal digital assistant, which is commonly called a PDA 38, a cell phone 40, and an Internet enabled television (TV) 42. Other examples would include a phone and any Internet enabled device 109 such as a refrigerator and vending machine.

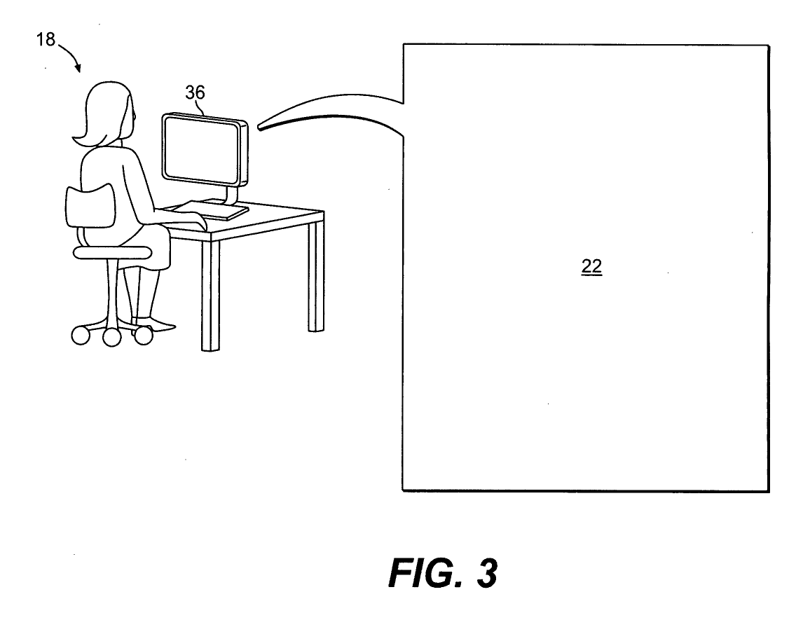

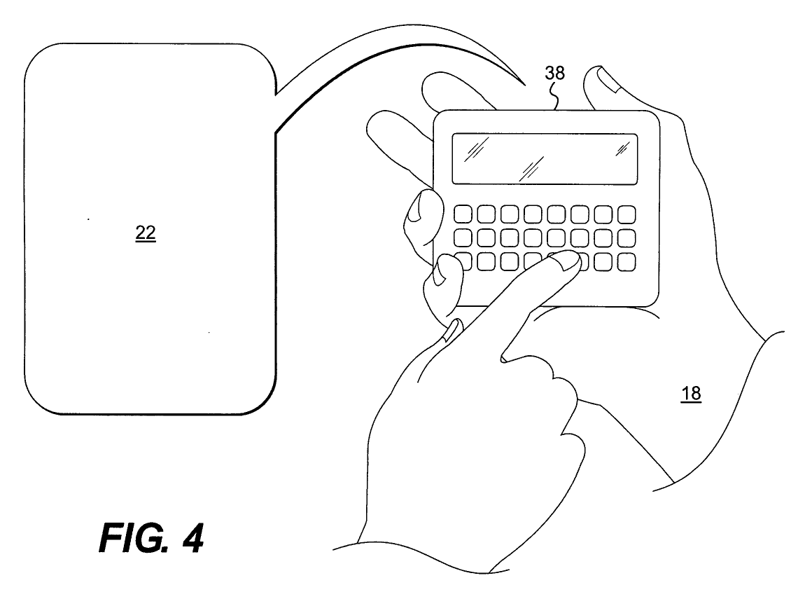

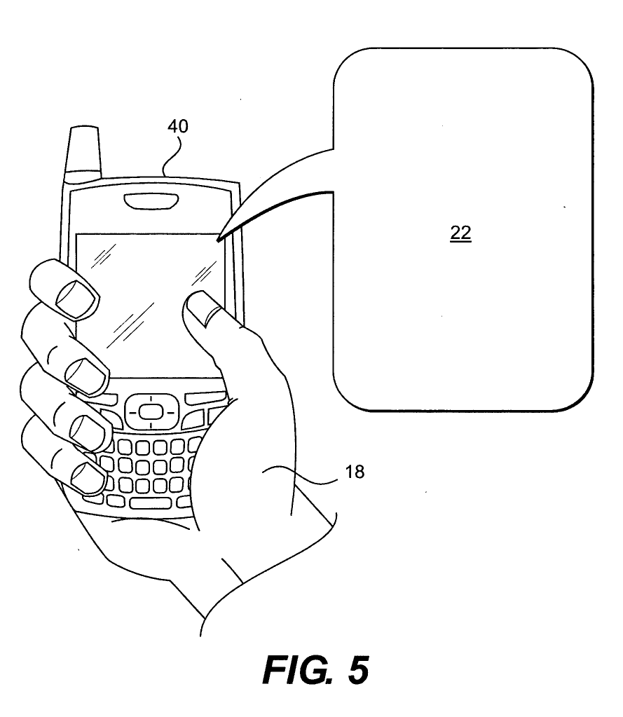

In this Specification and in the Claims that follow, the term “Alert” 22 means an advisement or warning. FIG. 3 shows a Second Person 18 receiving an Alert 22 on a computer 36. Alert 22 could read, for example, “Inappropriate content on home computer,” or “Check home computer usage as of 3 P.M.” or any customized text message. FIG. 4 shows a Second Person 18 receiving an Alert 22 on a PDA 38. The Alert could read, for example, “Go to your ISP's web site to view your son's IM,” or “Check your daughter's IM usage as of 3 P.M.” or any customized message. FIG. 5 shows a Second Person 18 receiving an Alert 22 on a cell phone 40. Alert 22 could read, for example, “Go to your cellular provider's web site to view your family's inappropriate content report,” or “Your cell phone carrier has uncovered inappropriate text messaging on your son's phone” or any customized text message.

In this Specification and in the Claims that follow, the term “Filter” 23 means any technological method that enables a Second Person 18 to view the Internet Activity 14 of a First Person 10.

Such a method can be implemented in software, hardware, firmware or the combination of hardware and software.

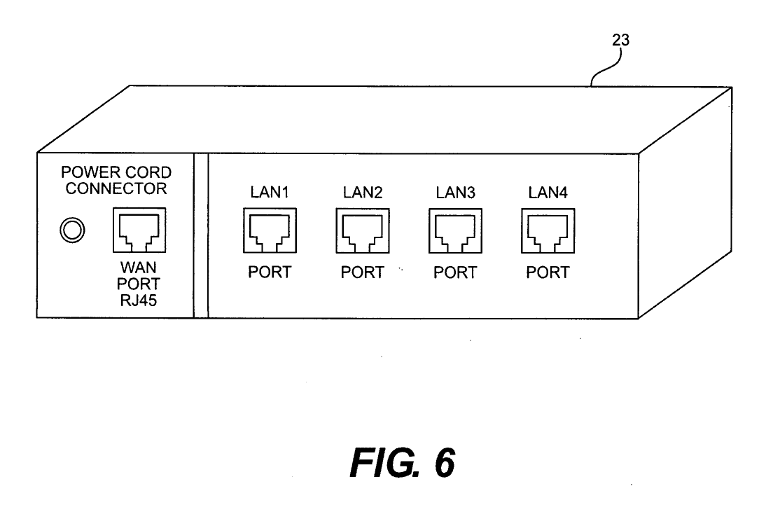

FIG. 6 shows one embodiment of Filter 23. In this embodiment, Filter 23 is a system that consists of hardware and software. In this embodiment, Filter 23 is a hardware device, which is a specialized or generic-purpose computer capable of running Filter 23 software. In this embodiment, Filter 23 hardware consists of a computer with disk storage and several local area network ports. FIG. 6 shows the back of the device.

In this Specification and in the Claims that follow, the term “Networking Device” 24 means a unit that enables digital information to travel across a network from one Information Appliance to another and back.

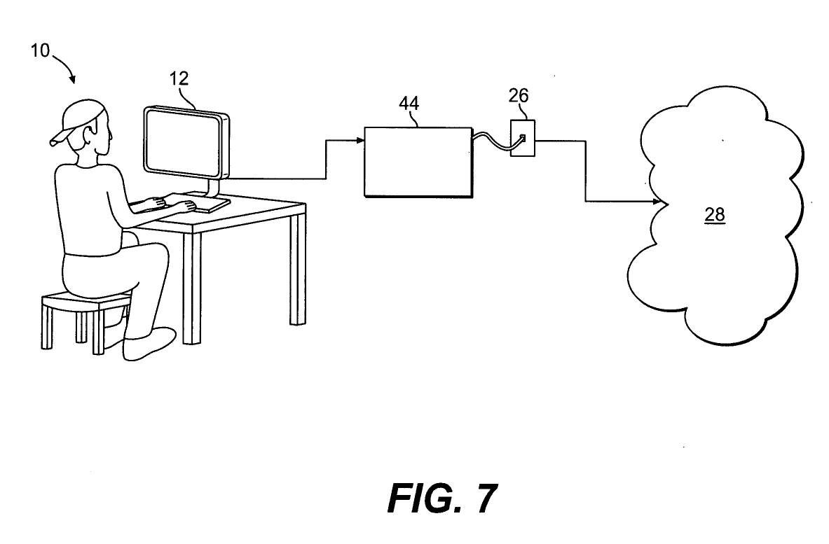

FIG. 7 shows a typical network configuration from a single computer to an Internet 28. First Person's Information Appliance 12 is connected to a Modem 44 which is connected to a wall jack 26. Wall jack 26 is typically wired to the outside world leading to an Internet 28.

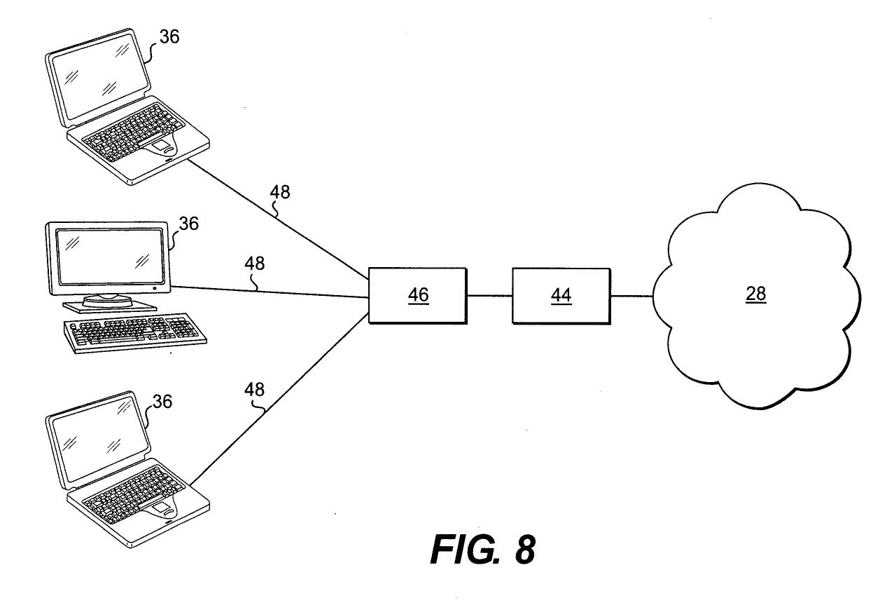

FIG. 8 shows a typical network configuration for multiple computers connected to an Internet 28. Computers 36 are connected to a router 46 which is connected to a modem 44 which is connected to an Internet 28. In this Specification, the local area network connection 48 could be wire or wireless.

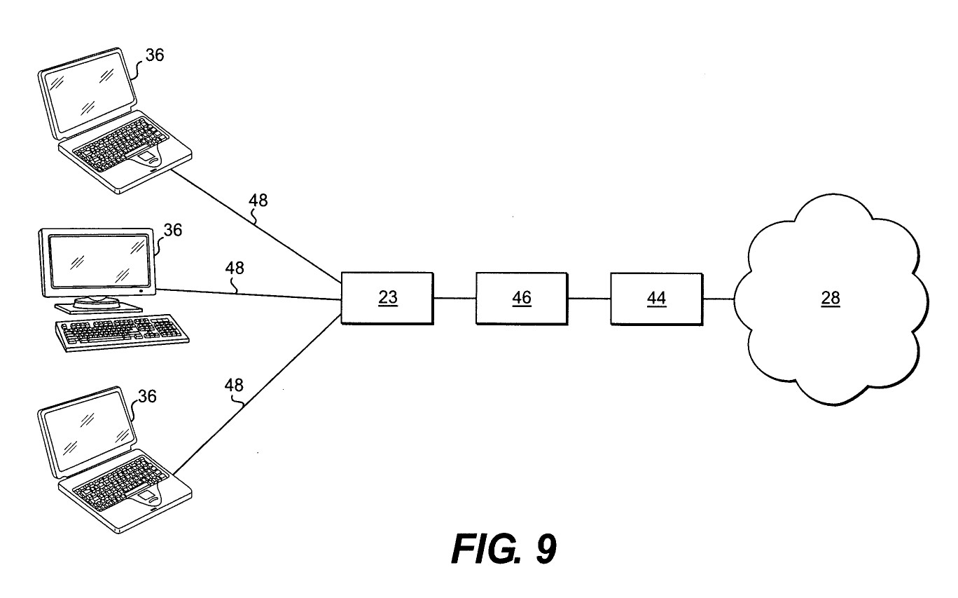

FIG. 9 shows a typical network configuration for more than one computer to an Internet 28 with one addition—a Filter 23 is added (by a Second Person 18 who wishes to monitor the Internet Activity 14 on that network). In this embodiment, said Filter 23 is a hardware device which is added in sequence before the computers connect to a router 46. Except for the addition of said Filter 23, everything remains the same as in FIG. 8.

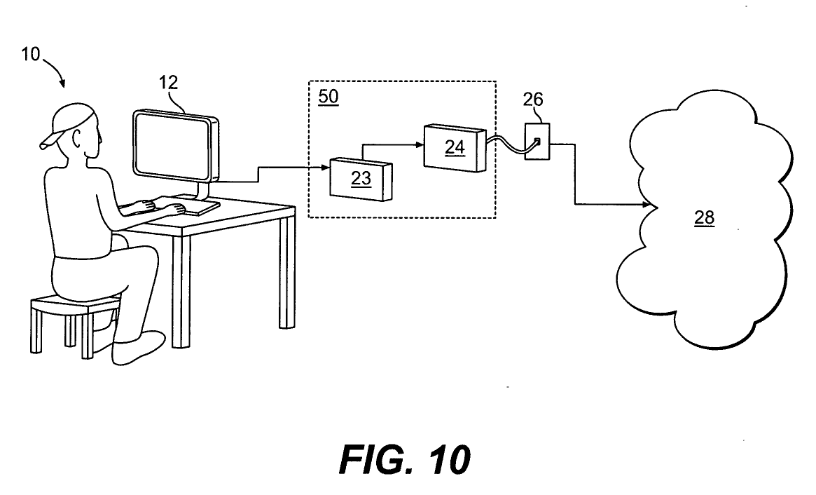

FIG. 10 shows a typical network configuration from a single computer to an Internet 28, and it shows one particular embodiment of the present invention where a Filter 23 and a networking device 24 are combined into one hardware unit 50.

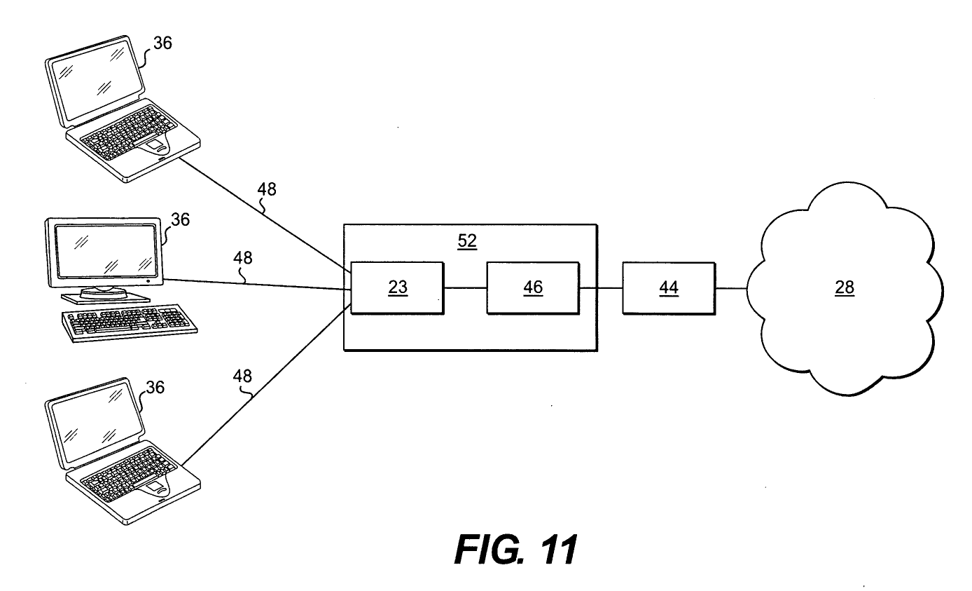

FIG. 11 shows a typical network configuration for more than one computer to an Internet 28, and it shows one particular embodiment of the present invention where a Filter 23 and a router 26 are combined into one hardware unit 52.

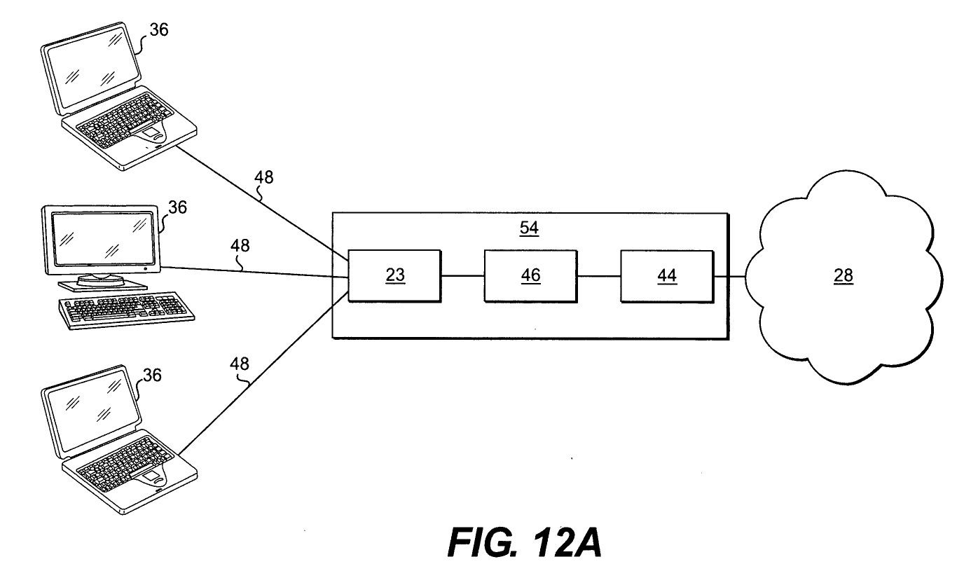

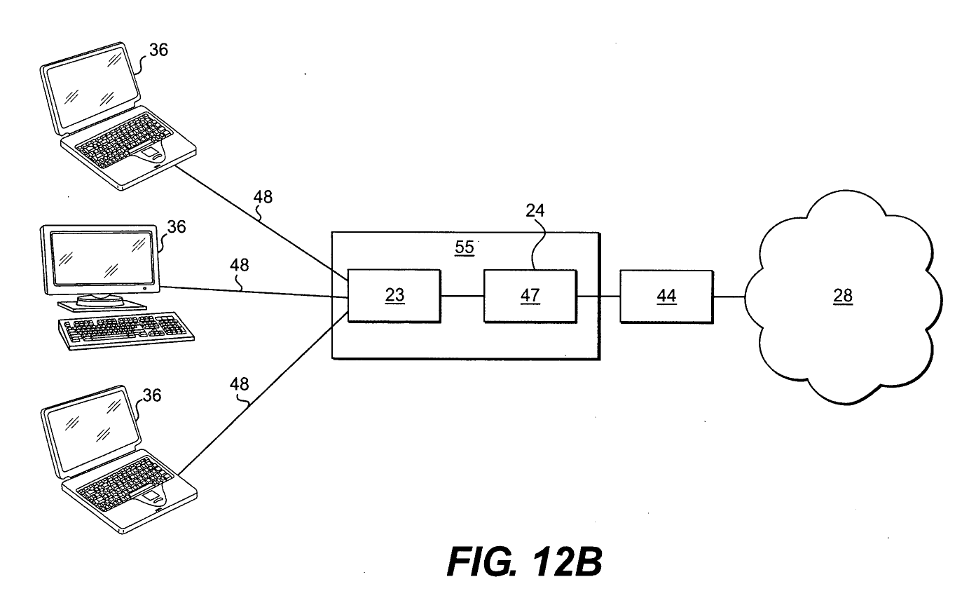

FIG. 12 consists of FIGS. 12A and 12B. FIG. 12A shows a typical network configuration for more than one computer to an Internet 28, and it shows a Filter 23, a router 26 and a modem 24 combined into one hardware unit 54. FIG. 12B shows another common network configuration for more than one computer to an Internet 28, and it shows a Filter 23 and a networking device 24 such as a networking switch 47 combined into on hardware unit 55.

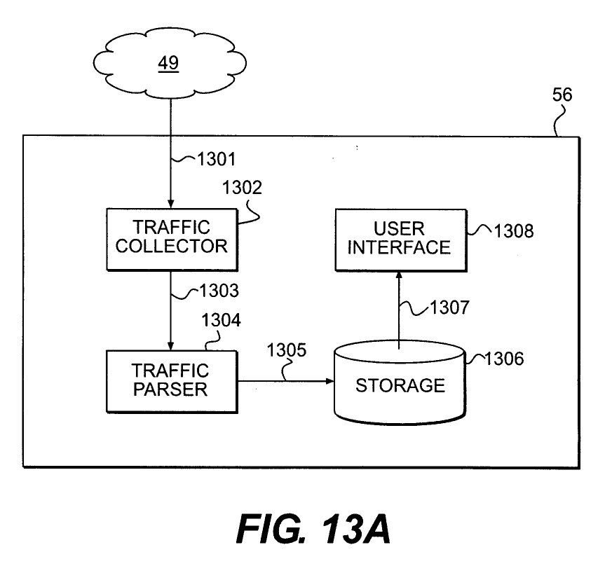

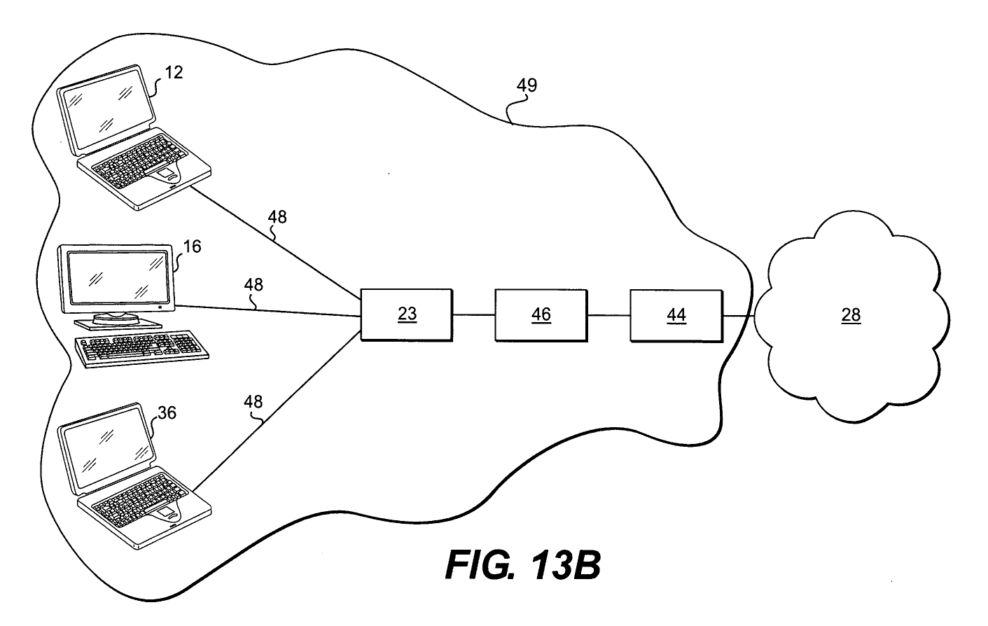

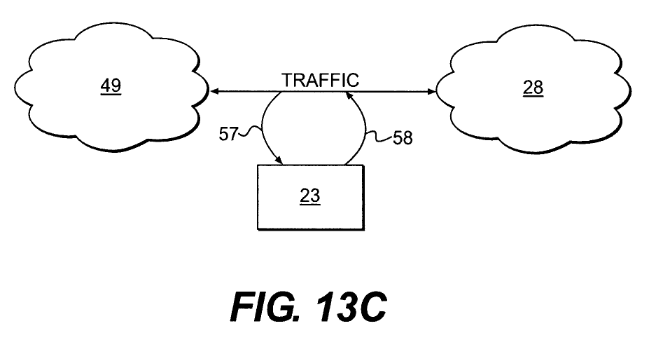

FIG. 13A shows the functional diagram 56 of a Filter 23.

Filter 23 software consists of the following functional elements and data flow which are shown in FIG. 13A: 1301) Traffic enters Filter 23, 1302) a data capture element called “Traffic collector,” 1303) Traffic enters a Traffic Parser, 1304) a data processing element called “Traffic parser,” 1305) data is sent for storage, 1306) a data storage element, 1307) data is sent for display, and 1308) a user interface.

In this embodiment, element 1302 captures packets from a network interface, maintains connection information, and discovers network topology. Element 1304 processes captured data by parsing traffic, dropping uninteresting packets, and retrieving necessary information from packets. Element 1306 stores processed data. Element 1308 presents processed data in a user-friendly format (including tables, charts and explanations with the entire data set reduced to just the meaningful data set).

FIG. 13B shows one embodiment of a connection schema of a Filter 23. Information Appliances such as First Person's Information Appliance 12, Second Person's Information Appliance 16, and PDA 38 are connected 48 to a local area network 49 along with several devices: a Filter 23, a router 46, and a modem 44. Said local area network 49 is connected to an Internet 28.

This connection schema makes Filter 23 installation extremely simple. A person simply has to reconnect two network cables and connect Filter 23 to a power socket. In this embodiment, Filter 23 software self-configures. No human intervention is required.

### Active Traffic Capturing

“Active capturing” means that every actual packet in a network is going through a Filter 23. When this happens, a Filter 23 can block or alter actual packets. FIG. 13B shows one embodiment of a schema of Active capturing. Filter 23 has all possibilities to block or alter traffic in both directions. For instance, it can block messages with inappropriate content 32 or replace such content with something more appropriate. One embodiment of building a device that can do Active capturing is to combine a Filter 23 with a Router 46 as shown in FIG. 11.

Passive Traffic capturing

“Passive capturing” is when a Filter 23 receives a copy of each packet 57 (as compared to receiving every actual packet). When this happens, a Filter 23 can't alter the actual data going through the network, but it can see all the traffic.

FIG. 13C shows one embodiment of a schema of Active capturing. While local area network 49 sends traffic to an Internet 28, a copy of the traffic 57 is sent to a Filter 23, and said Filter 23 is able to send traffic 58 back onto the network 49.

This embodiment has several advantages. It can be totally stealth, which means it cannot be detected. The processing requirements in this Passive capture schema are less than the processing requirements of an Active capture schema. Filter 23 under a Passive capture schema doesn't introduce any noticeable delay in the network traffic. In the case of a Filter 23 malfunction, the network traffic won't be affected under a Passive capture schema. Under a Passive capture schema, a Filter 23 still has a limited ability to block certain types of traffic by injecting special packets into a network 58. One embodiment of building a device that can do Passive capturing is to combine a Filter 23 with a networking device 24 as shown in FIG. 12B where said networking device 24 could be devices known as “bridges” or “sniffers.”

One embodiment of Filter 23 uses Passive capture, which costs less to build because it requires less processing power (i.e., cheaper computer)—which also means it is more affordable for a consumer to purchase in the home.

The connection schema for both active and passive capturing is the same. In one embodiment a person using a Filter 23 could decide to switch from Passive capture to Active capture and the only thing needed would be to reload new hardware with the same software.

### Traffic Processing

In one embodiment, a Traffic Parser 1303 makes two types of callbacks: periodic with statistics information and when a new packet is captured.

### Statistics Processing

In one embodiment regarding statistics, callbacks store collected information in a database 1306 and clear counters. Statistics data, in one particular embodiment, is shown in Table One.

```
TABLE ONE
HOSTS
CREATE TABLE t-hosts (
    fa_id INTEGER PRIMARY KEY,
    ft_found INTEGER NOT NULL DEFAULT 0,
    fb_visible INTEGER NOT NULL DEFAULT 1,
    fb_collect INTEGER NOT NULL DEFAULT 1,
    fb_router INTEGER NOT NULL DEFAULT 0,
    fm_mac  TEXT  NOT  NULL  UNIQUE
    DEFAULT  ‘00:00:00:00:00:00’
COLLATE NOCASE,
    fn-ip INTEGER NOT NULL,
    fs_label TEXT NOT NULL COLLATE NOCASE,
    fs_avatar_file TEXT NOT NULL DEFAULT ‘default.png’,
    fi_order INTEGER NOT NULL DEFAULT 10000
);
    Bad Words
CREATE TABLE t_bad-words (
    fa_id INTEGER PRIMARY KEY,
    fs_words TEXT NOT NULL COLLATE NOCASE
);
    Bad Servers
CREATE TABLE t_bad_servers (
    fa_id INTEGER PRIMARY KEY,
    fs_regexp TEXT COLLATE NOCASE
);
    Access Log
CREATE TABLE t_access-log (
    fa_id INTEGER PRIMARY KEY,
    ft_timestamp INTEGER NOT NULL DEFAULT 0,
    fb_success INTEGER DEFAULT 0,
    fn_ip INTEGER NOT NULL
);
    System Status Log
CREATE TABLE t_system (
    fa_id INTEGER PRIMARY KEY,
    ft_timestamp INTEGER NOT NULL DEFAULT 0,
    fi_the Filter_memory INTEGER DEFAULT 0,
    ff_load REAL NOT NULL, -- for 5 minutes from /proc/loadavg
    fi_memfree INTEGER NOT NULL DEFAULT 0,
    fi_swapfree INTEGER NOT NULL DEFAULT 0
);
CREATE TABLE t_protocols (
    fa_id INTEGER PRIMARY KEY,
    fi_port INTEGER NOT NULL,
    fd_protocol INTEGER NOT NULL, -- 0=TCP, 1=UDP
    fs_name TEXT NOT NULL,
    fs_description TEXT NOT NULL
);
```

Table t_traffic_summary is a non-essential table that speeds up generating user views that represent traffic information for a given period of time. Logically records for t_traffic_summary table are generated in a data storage implementation class.

Table t_traffic contains significantly more information and from that table more advanced reports could be generated, such as: what computers produce the most traffic, most popular servers accessed from a local network, and most popular protocols in a local network.

### Packet Processing and Storing

In one embodiment, a packet processing of Filter 23 is based on a free public source library known as “libpcap,” which is described by Wikipedia.Org as “libpcap . . . is the packet capture and filtering engine of many open source and commercial network tools.” It consists of a number of callbacks registered to receive certain types of traffic (such as TCP or UDP). TCP is defined by wikipedia.org as “a transportation protocol that is one of the core protocols of the Internet protocol suite.” UDP or User Datagram Protocol is defined by wikipedia.org as “one of the core protocols of the Internet protocol suite. Using UDP, programs on networked computers can send short messages sometimes known as datagrams to one another. UDP is sometimes called the Universal Datagram Protocol.” In this embodiment, each callback (called a packet handler) receives a structure containing either a parsed packet (for UDP) or parsed packet and supplemental information (TCP session description). A handler tries to process a packet. If the parsing is successful then the result of processing is sent to the class responsible for storing the processing results to data storage. If it is not, the handler can mark the TCP session as not being of interest for a given handler.

Resulting data for processed protocols, in one particular embodiment, is shown in Table Two.

```
TABLE TWO
    Instant Messages
CREATE TABLE t_im (
    fa_id INTEGER PRIMARY KEY
    ft_timestamp INTEGER NOT NULL DEFAULT 0,
    fi_from_host-id INTEGER NOT NULL,
    fi_to_host-id INTEGER NOT NULL,
    fs_from TEXT NOT NULL COLLATE NOCASE,
    fs_to TEXT NOT NULL COLLATE NOCASE,
    fd_protocol INTEGER NOT NULL,
    fx_message TEXT COLLATE NOCASE,
    fb_unicode INTEGER,
    fi_month INTEGER NOT NULL,
    fi_day INTEGER NOT NULL
);
    Posts
CREATE TABLE t-webposts (
    fa-id INTEGER PRIMARY KEY,
    ft_timestamp INTEGER NOT NULL, DEFAULT 0,
    fi_from_host_id INTEGER NOT NULL,
    fi_to_host_id INTEGER NOT NULL,
    fs_from TEXT NOT NULL COLLATE NOCASE,
    fs_to TEXT NOT NULL COLLATE NOCASE,
    fs_subject TEXT NOT NULL COLLATE NOCASE,
    fs_protocol INTEGER NOT NULL -- Gmail, phpBB, IPB etc
    fx_message TEXT COLLATE NOCASE,
    -- fb_unicode INTEGER, -- the message is in Unicode,
    currently not used
    fi_month INTEGER NOT NULL,
    fi_day INTEGER NOT NULL
);
    Urls
CREATE TABLE t_urls (
    fa_id INTEGER PRIMARY KEY
    ft_timestamp INTEGER NOT NULL DEFAULT 0,
    fi_from_host_id INTEGER,
    fi_to_host_id INTEGER,
    fs_server TEXT NOT NULL COLLATE NOCASE, -- server
    dns name
    fs_uri TEXT NOT NULL COLLATE NOCASE, -- the full uri
    fs_content_type TEXT COLLATE NOCASE,
    fi_content_length INTEGER NOT NULL DEFAULT 0,
    fi_month INTEGER NOT NULL,
    fi_day INTEGER NOT NULL
);
    Mail table
CREATE TABLE t_mail (
    fa_id INTEGER PRIMARY KEY,
    ft_timestamp INTEGER NOT NULL DEFAULT 0,
    fi_from_host-id INTEGER NOT NULL,
    fi_to_host_id INTEGER NOT NULL,
    fs_from TEXT NOT NULL COLLATE NOCASE,
    fs_to TEXT NOT NULL COLLATE NOCASE,
    fs_cc_{—} TEXT COLLATE NOCASE,
    fs_subject TEXT NOT NULL COLLATE NOCASE,
    fi_raw_mail_size INTEGER NOT NULL,
    fs_raw_mail_file TEXT NOT NULL,
    fi_month INTEGER NOT NULL,
    fi_day INTEGER NOT NULL
);
    VoIP table
CREATE TABLE t_voip (
    fa_id INTEGER PRIMARY KEY,
    ft_timestamp INTEGER NOT NULL DEFAULT 0,
    fi_from_host_id INTEGER NOT NULL,
    fi_to_host_id INTEGER NOT NULL,
    fi_from_port INTEGER NOT NULL DEFAULT 0,
    fi_to_port INTEGER NOT NULL DEFAULT 0,
    fs_from_name TEXT NOT NULL COLLATE NOCASE,
    fs_from_number TEXT NOT NULL COLLATE NOCASE,
    fs_to_name TEXT NOT NULL COLLATE NOCASE,
    fs_to_number TEXT NOT NULL COLLATE NOCASE,
    fs_call_id TEXT NOT NULL COLLATE NOCASE,
    fs_rec_file TEXT NOT NULL,
    fi_month INTEGER NOT NULL,
    fi_day INTEGER NOT NULL,
    -- this part is filled upon call end
    fi_duration  INTEGER NOT NULL DEFAULT 0,
    fi_failure_code INTEGER NOT NULL DEFAULT 0,
    fi_end_reason INTEGER NOT NULL DEFAULT 0
);
    Unaggregated Traffic
CREATE TABLE t_traffic (
    fa_id INTEGER PRIMARY KEY,
    ft_timestamp INTEGER NOT NULL DEFAULT 0 --unix
timestamp, TZ adjusted
    fi_from_host_id INTEGER NOT NULL, -- id of the originating
    host
    fi_to_host_id INTEGER NOT NULL, -- id of the destination host
    fi_from_port INTEGER NOT NULL,  -- originating port number
    fn_remote-ip INTEGER NOT NULL, -- ip address of the remote
host
    fi_to_port INTEGER NOT NULL,  -- destination port number
    fi_bytes_in INTEGER NOT NULL,  -- #bytes received by local
network
    fi_bytes_out INTEGER NOT NULL,  -- #bytes sent to the internet
    fd_protocol INTEGER DEFAULT 0  -- TCP=0, UDP=1
);
    Traffic Summary
CREATE TABLE t_traffic_summary (
    ft_timestamp INTEGER NOT NULL DEFAULT 0,
    fi_bytes_in INTEGER NOT NULL,
    fi_bytes_out INTEGER NOT NULL,
    fi_year INTEGER NOT NULL,  -- the year of data acquisition
    fi_month INTEGER NOT NULL, -- the month of data acquisition
    fi_day INTEGER NOT NULL  -- the hour of data acquisition
);
```

The instant messages from different types of instant messaging software such as ICQ, AIM, Yahoo! Messenger, MSN messenger are stored in Table t_im. Table t_urls contains the detailed list of which URLs were accessed. Table t mail contains information about email messages. The messages themselves are stored in a separate folder on disk. VoIP calls information is stored in Table t_voip. When it is possible the phone conversation is also reordered and the conversation is stored in a separate folder on local disk as a .WAV file. Table t_webposts contains messages sent to the web using web interface, such as various web mail interfaces, forums like phpBB or Invision Power Board, websites like LiveJournal.

### Discovery

One of the important functions of Filter 23 data capturing 1302 and parser 1304 performs is network topology discovery. In one embodiment, the algorithm used is:

1. Every traffic record that goes to the database has originating and destination host id. Such ID is taken from the Table t_hosts by MAC address.
2. If Table t_hosts doesn't contain such record the executable creates new one with given IP and MAC addresses.
2.1 If the IP/MAC match multicast traffic range, then the host is marked is invisible to the end user.
2.2 If the IP matches Filter 23 hardware IP, then it is marked as invisible and exempt from monitoring.
3. An initial executable runs in the router discovery mode, and it doesn't record any traffic statistics or traffic records.
3.1 This executable records all IP addresses it sees associated with a given MAC address.
3.2 When it sees more than ROUTER_DISCOVERY_FACTOR (currently 3) different IP addresses behind some MAC address, it marks the given host as router and leaves router detection mode. From this point it can detect direction of network traffic and can start recording statistics and parsed protocols records.
3.3 Since all traffic coming from the internet comes from router and has router's MAC address, the router host in the database is marked as “All traffic” and by selecting this host in the hosts list, user can see all internet traffic from the local network.

Wikipedia.org defines a MAC address as “Media Access Control address (MAC address) or Ethernet Hardware Address (EHA) or hardware address or adapter address is a quasi-unique identifier attached to most network adapters (NICs). It is a number that acts like a name for a particular network adapter, so, for example, the network cards (or built-in network adapters) in two different computers will have different names, or MAC addresses, as would an Ethernet adapter and a wireless adapter in the same computer, and as would multiple network cards in a router.”

In this embodiment, the executable ignores all local traffic it sees (the traffic that goes not from/to the router). For instance, all accesses to Filter 23 itself are not included as statistics.

Because frequent database access will cause significant performance degradation, in this embodiment Filter 23 executable reads Table t_hosts on start and then makes all modifications both in data storage and memory. This means that the table is modified by external process such as a Web User Interface. Filter 23 will reload the table. Filter 23 executable will be notified about such event for instance by sending a system signal (like SIGHUP).

### Data Storage

Physically the data could be stored in any type of storage (for instance in plain files). In one embodiment, Filter 23 supports storing data in several modern types of databases. In this embodiment with respect to Filter 23 data capturing and processing executable, the data storage interface is implemented as a utility class—one for each supported type of software. The class must implement an abstract interface that allows processing structures representing each type of processing result returned by packet handlers. Thus, new database support can be easily added in the future. In this embodiment for the User Interface, the connection to the database is optimized for the given database, so modifications of user interface code might be required for the new database types supported. In this embodiment, the data storage implementation in the executable also precalculates some synthetic fields to speed up data displaying to the user. For instance, most tables contain fields with the year, month, day and hour of data acquisition.

In this embodiment, portions of sample database definition shown in Table t_hosts is the one to which most other tables are linked. It lists all local hosts discovered and multicast addresses used. For user convenience, the host and multicasts are hidden from the user interface by default. The hosts are added to the Table t_hosts after passive discovery. Tables t_bad_words and t_bad_servers list the words and servers which are considered dangerous. The content of these tables is used as described in the Index 70 description. Table t_access_log contains the list of all attempts to login to the user interface. This table is necessary for security purposes. Table t_system is implemented for debugging purpose only. In this embodiment, Filter 23 software includes a script that runs periodically and writes current hardware CPU load, memory available and other characteristics to a table. Later the data stored in the table could be visualized to developers using debugging interface. Debugging interface is a part of generic User Interface enabled by configuration parameters. Table t_protocols is used to display a meaningful protocol name to the user. The protocols list is taken from /etc/services file for Linux OS distribution.

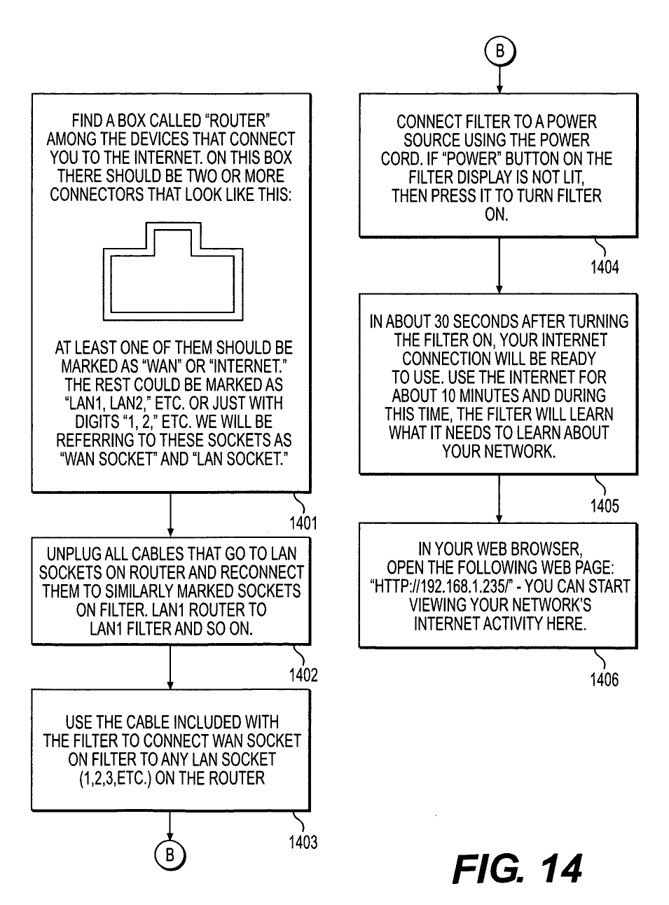

FIG. 14 shows one embodiment of installation directions for a Filter 23. A Second Person 18 having no knowledge of or expertise with computers and peripheral equipment could successfully install Filter 23 as embodied as hardware in FIG. 6. The first direction 1401 reads:

Find a box called a “Router” among the devices that connect you to the Internet. On this box there should be two or more connectors that look like this.

A picture of a receptacle is shown. The text continues:

At least on of them should be marked as “WAN” or “Internet.” The rest could be marked as “LAN1, LAN2,” etc. or just with digits “1, 2,” etc. We will be referring to these sockets as “WAN socket” and “LAN socket.”

### The Next Direction 1402 Reads:

Unplug all cables that go to LAN sockets on Router and reconnect them to similarly marked sockets on Filter. Lan 1 Router to Lan 1 Filter and so on.

### The Next Direction 1403 Reads:

Use the cable included with the Filter to connect WAN socket on Filter to any LAN socket (1, 2, 3, etc.) on the Router.

### The Next Direction 1404 Reads:

Connect Filter to a power source using the power cord. If “Power” button on the Filter display is not lit, then press it to turn Filter on.

### The Next Direction 1405 Reads:

In about 30 seconds after turning the Filter on, your Internet connection will be ready to use. Use the Internet for about 10 minutes and during this time, the Filter will learn what it needs to learn about your network.

### The Next Direction 1406 Reads:

In your web browser, open the following web page “http://192.168.1.235/”—you can start viewing your network's Internet Activity here.

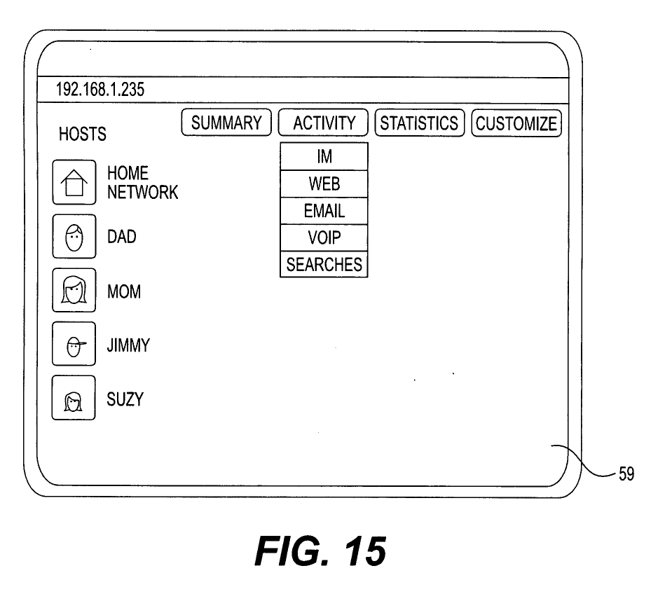

FIG. 15 shows one embodiment of a user interface 58 of a Filter 23. A Second Person 18 having no knowledge of or expertise with computers and information appliance user interfaces could successfully use a Filter 23 through an easy-to-use interface 58 as presented in FIG. 15. All one has to do is move the cursor around and click. In this embodiment, there is a list of “hosts” on the left part of the screen which show a picture of each host, which includes: home network, dad, mom, Jimmy, and Suzy. Across the top of the screen, a user can click on: Summary, Activity, Statistics, and Customize. In this embodiment, when the user clicks on “Activity” a set of choices is shown in a pull down menu: IM, Web, Email, VoIP, and Searches. A Second Person 18 (a mom) could view the instant messages of a First Person 10 (son Jimmy or daughter Suzy) by selecting “IM” in the menu. Likewise, a Second Person 18 could view web activity or email activity or VoIP activity or web search activity of a First Person 10.

In this Specification and in the Claims that follow, the term “email” (also known as “Electronic Mail”) means the exchange of computer-stored messages by telecommunication.

In this Specification and in the Claims that follow, the terms “IM” and “Instant Message” are defined by web site “webopedia.com” as “Abbreviated IM, a type of communications service that enables you to create a kind of private chat room with another individual in order to communicate in real time over the Internet, analagous to a telephone conversation but using text-based, not voice-based, communication. Typically, the instant messaging system alerts you whenever somebody on your private list is online. You can then initiate a chat session with that particular individual.”

In this Specification and in the Claims that follow, the term “web search” means: “To use one of the hierarchical subject guides or search engines available from a Web Browser to identify and retrieve information housed on the World Wide Web.”

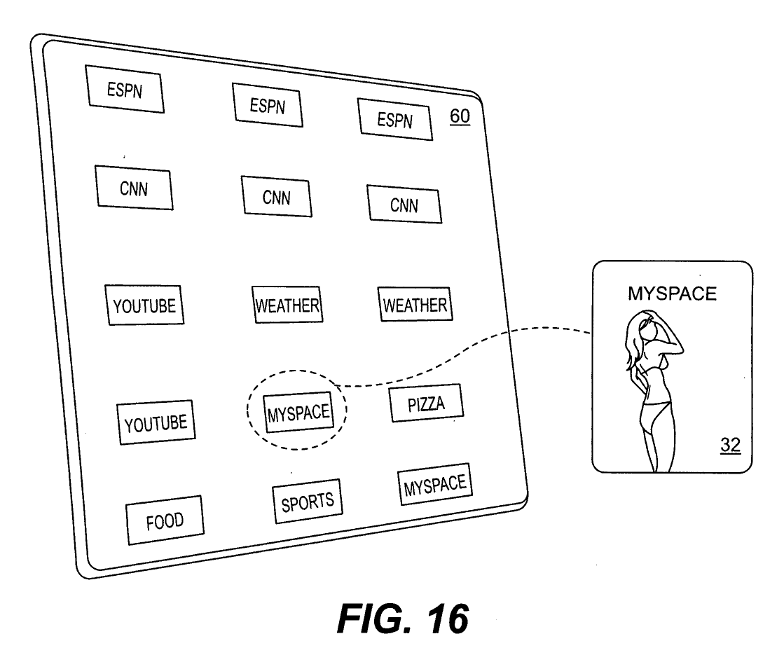

In this Specification and in the Claims that follow, the term “VOIP,” which is short for Voice over Internet Protocol, means a category of hardware and software that enables people to use the Internet as the transmission medium for telephone calls by sending voice data in packets using IP rather than by traditional circuit transmissions of the PSTN. FIG. 16 shows a panorama 60 of a representation of all the web sites visited (within a certain time frame) by a First Person 10 and shows how a Second Person 18 can quickly view the pictures from each web site visited; it shows how a Second User 18 can quickly identify and judge the MySpace web site page as being inappropriate Internet Activity 32. It shows how a Second User 18 can quickly flag and inspect all MySpace web site activity.

An Internet 28 can be a place where Inappropriate Internet Activity 32 can be viewed. “Inappropriate” is a subjective term. One parent could find some activity or material inappropriate for their teenage child while another parent could render that same material as appropriate. Likewise, an employer could opine certain Internet Activity 14 of an employee as being inappropriate 32. Examples of Internet Activity 14 that could be deemed inappropriate by a Second Person 18: viewing pornographic material, entering chat rooms, entering chat rooms where predators are known to have been, instant messaging, any form of electronic communication (e.g., instant messaging, email, web mail, etc.) where the subject matter in a communication is age inappropriate according to the Second Person 18, and any form of Internet Activity 14 where the subject matter being viewed is not consistent with a First Person's 10 job description.

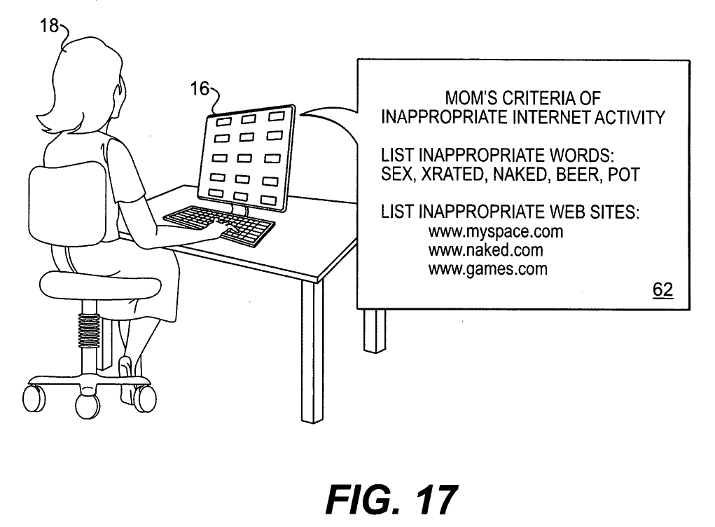

FIG. 17 shows one embodiment of a Second Person 18 on a Second Person's Information Appliance 16 establishing criteria 62 to judge the appropriateness of Internet Activity 14. In this embodiment, a Second Person 18 is obviously a mom, and the mom is able to instruct a Filter 23 on what to look for from the Internet Activity 14 that is being viewed by a First User 10 (see FIG. 1A). A user interface on the Information Appliance 16 shows a title “Mom's Criteria of Inappropriate Internet Activity” and, for this embodiment, the entry of “inappropriate words: sex, xrated, naked, beer, pot” and the entry of “inappropriate web sites: www.myspace.com, www.naked.com, www.games.com.”

Examples of First Persons 10 using an Internet 28 and having Internet Activity 14 that is worthwhile to inspect by a Second Person 18 are: children, husbands, wives, students, school officials, employees, citizens, supervisors, managers, and sales managers. Examples of Second Persons 18 who find value in inspecting Internet Activity 14 of First Persons 10 are: parents, guardians, teachers, schools, employers, wives, husbands, investigators, and governments.

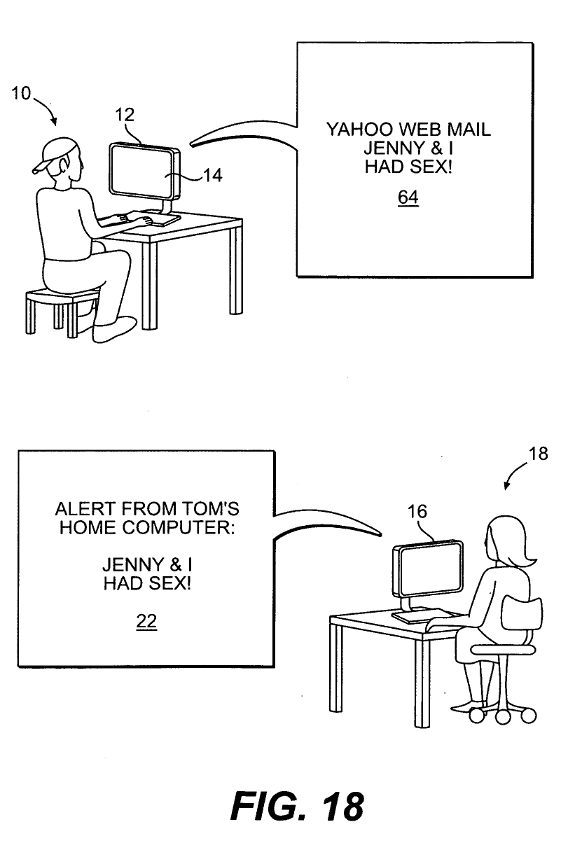

FIG. 18 shows a Second Person 18 on their Information Appliance 16 receiving an Alert 22 regarding a First Person's Internet Activity 14 on First Person's Information Appliance 12. In this embodiment, Internet Activity 14 is Web Mail 64 and First Person 10 is Tom, son of Second Person 18. In this embodiment, an Alert 22 reads “Alert from Tom's web mail: Jenny & I had sex!”

If a parent judges that a subset of Internet Activity 14 is inappropriate 32 for its child, then a parent may want to see that subset of inappropriate Internet Activity 32. If parents are made aware of when and what kind of inappropriate Internet Activity 32 is seen, they can intervene, if they choose, according to their own timeline, parenting philosophy, and parenting style when said inappropriate Internet Activity 32 is viewed by their child. Some parents might see an Alert 22 as shown in FIG. 18 and think: “I don't want my son having sex.” Another parent might think: “I need to speak to my son about birth control.” Another might say: “I need to speak to Jenny's parents right away.” In any case, without the current invention parents have no opportunity to know about Internet Activity 14 they deem inappropriate 32 and no opportunity to intervene. The current allows parents that opportunity.

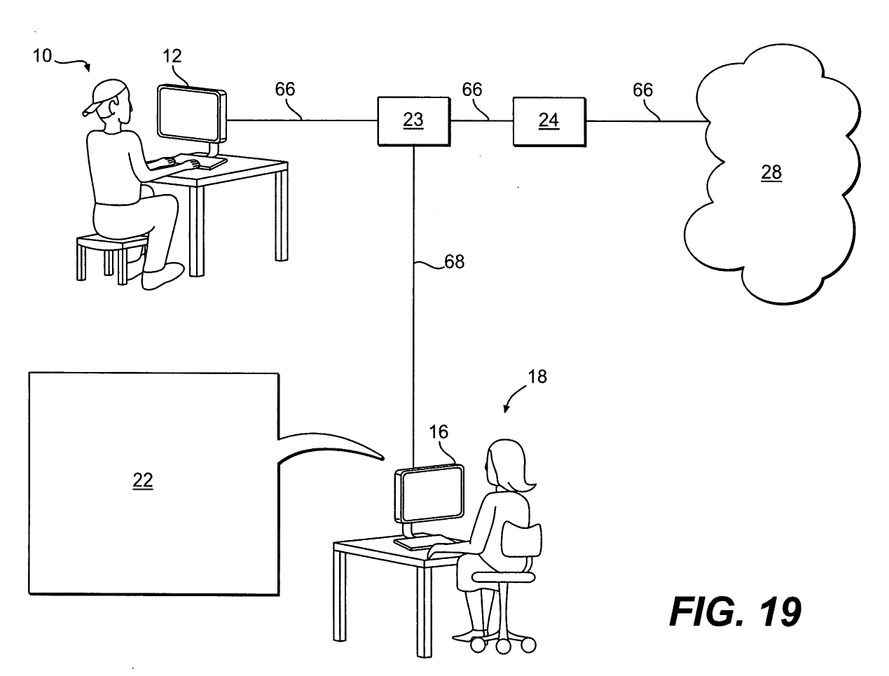

FIG. 19 shows a First Person 10 on a First Person's Information Appliance 12 transmitting encrypted traffic 66 on a network. A Filter 23 is installed; traffic transmits to a modem 24 and an Internet 28 unaffected, but at the same time decrypted traffic 66 and transmits to a Second Person 18 on their Information Appliance 16, which receives an Alert 22 from Filter 23.

In this Specification and in the Claims that follow, the term “encryption” means “the process of converting information into a form unintelligible to anyone except holders of a specific cryptographic key.” In this Specification and in the Claims that follow, the term “encrypted traffic” means electronic traffic, such as Internet 28 traffic generated by a Computer 36 or Information Appliance 12 that has undergone encryption. In one embodiment, Filter 23 is equipped to decrypt encrypted traffic, thus making it possible for a Second Person 18 to monitor an Internet Activity 14 of a First Person 10 even when said traffic from First Person's Information Appliance 12 is encrypted traffic 66.

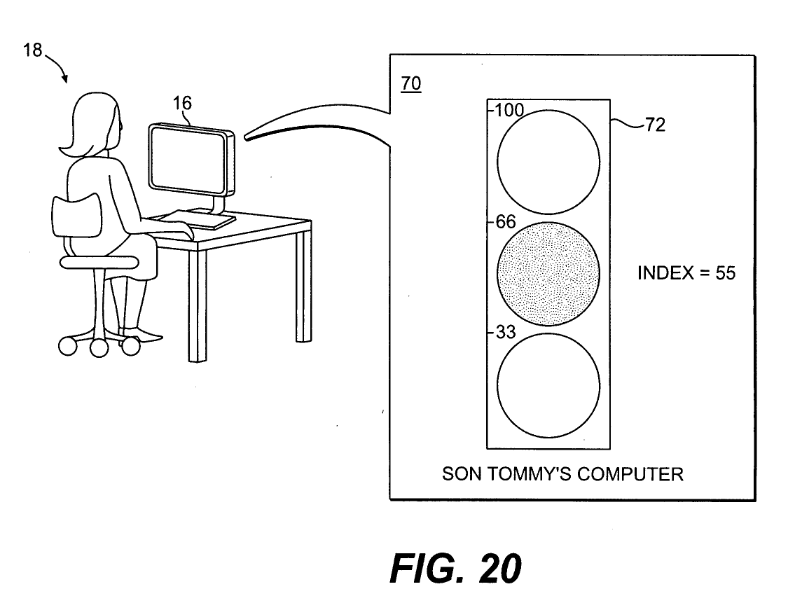

FIG. 20 shows a Second Person 18 on their Information Appliance 16 viewing an Index 70. This FIG. 20 shows one embodiment of an Index 70, which is a graphic representation of a traffic stop-light 72. The graduated scale is from zero to one hundred. From zero to 33 is the green light. From 33 to 66 is the yellow light. From 66 to 100 is the red light. In this FIG. 20, an Index 70 equals 55 and the yellow light is lit up. A First Person 10 is Tommy, son of a Second User 18. In this Specification and in the Claims that follow, the term “Index” means any number, letter, symbol, or combination thereof, or method which is meant to represent an evaluation of Internet Activity 14 against a criteria 62. Without an Index 70, Second Person's 18 seeking to view and judge Internet Activity 14 would have to spend a lot of time rummaging through reams of Internet Activity 14 raw data. With an Index 70, Second Person's 18 seeking to view and judge Internet Activity 14 simply by viewing an Index 70. Index 70 could save a Second Person 18 hundreds of hours per year in viewing and judging Internet Activity 14. Likewise, Index 70 could save an employer millions of hours each year in viewing and judging Internet Activity 14 of employees.

Index 70 can be used to summarize the level of appropriateness of Internet Activity 14 as a letter, figure, symbol, graph or place on a graduated scale.

In one embodiment, Index 70 is called Content APpropriateness inDEX or “CAPDEX.”

In one embodiment, Index 70 is a float value in the range of zero to one. The number in between zero and one would characterize content appropriateness according to set of parameters. Value zero means absolutely appropriate content and one means absolutely inappropriate.

One embodiment of Index 70 is in software. Index 70 is the result of a specially designed function C(D,P), where:
D(d, . . . , dN) is a data vector where each of d sub i belongs to a certain predefined finite set; and
P(p1, . . . , pM) is a parameter list where each p sub i belongs to a certain predefined set. In one embodiment D(d1, . . . , dN) is the subset of data sent from and to Internet 28 as part of Internet Activity 14.

In one embodiment, when calculating Index 70 for multiple groups of Internet Activity 14 (for instance for multiple users of a network), the parameters may include the weight for each group as well as significance of different factors for each group.

In one embodiment, a Second Person 18 defines what is considered inappropriate 62 by setting parameters P(p1, . . . , pM). For instance, if a parent wants to know how much dangerous content or Internet Activity 14 was downloaded by a child in a monitored network, the parent can do this with one set of parameters. If a parent wants to see similar characteristics for how many “good” websites with news, scientific articles or online books were browsed by a child, this also could be done by providing another set of parameters.

In one embodiment, since Index 70 provides emphasis on a given characteristic of the Internet Activity 14, it is generally untrue that good=1−bad. In certain definitions of C, each of those parameters has to be calculated separately.

Index 70 requires Internet Activity 14 analysis. In one embodiment, since an Index 70 value should adequately and simply represent Internet Activity 14 quality, its function C(D,P) should respond to the following situations that take place in a network environment when Internet Activity 14 D is taken from a network.

In one embodiment, Index 70 function should greatly increase in value in the situations listed below:
Downloading a large number of content items at once from a source that is known to be bad 32. For instance if someone downloaded a large number of pornographic files, one might try to hide that fact by downloading large amount of appropriate content to lower the ratio of inappropriate content. This means that C(D,P) should not be a simple ratio between content types, but use more sophisticated methods of analysis.

Downloading large number of content items from a source that is known to be bad 32 for a long period of time. For instance, one should not be able to hide/mask inappropriate content downloading by distributing it in time.

Searching for content known to be bad 32. For instance if a child looks for word “porn” in a search engine, this is significantly more dangerous than just opening an article where this word is mentioned.
Downloading large files, such as video or archive, from a website with a dangerous name 32. Such large files could be archives of dangerous content and could contain more inappropriate content than a single image or small text file.
Downloading certain types of files from sources known to be bad 32. For instance, downloading torrent files with inappropriate words in the file name could mean that a person has an intent to download a large volume of inappropriate content.
Sending a communication messages with inappropriate words 32 in the body and subject. For instance that could be words “job search” in the case of company or “porn” in the case of a child or “terror” in the case of a public Internet 28 access place.
Sending a communication message to destinations known to be inappropriate 32. For instance a company might want to monitor situations when too many employees are sending resumes to job websites. In this case, Index 70 would be a great indicator of company health.
Sending communication messages of inappropriate type 32. For instance, a company might set a policy that no attachments could be sent in emails in order to avoid information leaks. Or a school might prohibit sending and receiving pictures and music.

If in one embodiment, an Index 70 represents a person's intent to view inappropriate material 32 over an Internet 28, then an Index 70 function should ignore or give little value increase in the following situations:
Random or rare access of inappropriate content 32 when it appears irregularly and has only a small percentage in the whole data. For instance, spam and advertisements should not affect Index 70 much (unless the Second Person 18 initiating the monitoring wishes for it to affect Index 70 more).
Receiving communication messages with inappropriate content 32. For example receiving spam messages with dangerous words should not affect Index 70 much (unless the Second Person 18 initiating the monitoring wishes for it to affect Index 70 more).

In one embodiment, Index 70 could be applied to groups versus individuals. An Index 70 calculation discussed in this Specification could be applied to individuals, multiple users, individual points of internet access (like terminals or computers) and whole networks.

In one embodiment, when Index 70 is calculated for a whole network, the following should be taken into account:
Each user should have its own weight in the total;
Index 70 for each user might be calculated using an individual algorithm;
For simplicity, it makes sense to group users in the network and have separate weights and separate algorithms for each group rather than for each user; and
For simplicity the algorithm for each group could be the same, but different parameters should be used for each group. In most cases, the parameters will be lists of inappropriate words and sources.

Depending on a Filter's 23 purpose, the groups of users could be either defined by user (for instance large companies may want to establish complex hierarchical structure of groups) or predefined by a Filter 23 manufacturer (for instance a Filter 23 for homes might have just two groups: adults and children). For simplicity and in one embodiment, the groups in the home edition are not visible to parent 18 at all. Instead, parent 18 provides birthdates of the family members 10 and Filter 23 could assign groups (child or parent) to each family member based on that information.

In one particular embodiment, the Index function for Filter 23 (ICF) could work as follows:
ICF takes into consideration only cases of inappropriate content. For instance two situations listed below (A and B) will produce the same Index value for 1 day period:
A: if someone was loading only appropriate content for 1 hour and inappropriate only for 10 minutes
B: if someone was loading only appropriate content for 10 hours and inappropriate content only for 10 minutes

For instance, if an employee sent out an email with confidential information or a child sent a parent's credit card information, it doesn't matter how good they were for the next several hours—the situation that requires attention already happened and it will be reflected as a high Index value.

If running on powerful hardware, Filter 23 will provide both index of inappropriate content (for instance how many bad websites were visited) and appropriate content (how many website related to homework were visited).

ICF is not a simple ratio between bad and good content. For instance, it could reflect the difference between watching 10 pornographic images out of 1,000 total images is much bigger than the difference between 1,000 out of 100,000.

ICF doesn't have to take time into account; it considers only elementary operations. For instance in the situation when 1,000 images were downloaded during the day and when the same amount was downloaded in just 1 minute the ICF could return the same value. This might seem a bit unfair from the prospective of time spent browsing porn content, but it is reasonable for some parents wishing to take into account the fact that when the content is watched offline Filter 23 can't detect it by monitoring network traffic only (In another implementation, Filter 23 could work in cooperation with agents installed on each computer and then this assumption will be changed).

### Data Vectors

In one embodiment, Filter 23 analyzes standard Internet interaction records that contain the following fields:

CT—Communication Type. For instance: mail, instant message, web post (such as live journal or phpBB), voip call, web access, search
DIR—Direction of Connection of type Enumeration: Incoming, outgoing
SIP—Internet Activity origination IP Address

### DIP—Internet Activity Destination IP Address

DS—Data size or duration represented In bytes for binary data or in seconds for VOIP calls.
MT—Media Type. For instance: text, archive, image, video, generic binary data, voip call, p2p file (such as torrent). More types can be added in alternative embodiments. Data1, Data 2, Data 3, . . . —Payload parameters that contain parts of the original Internet Activity. For instance: email subject, instant message text, bittorrent file name.

In this Specification and the claims that follow, the term “IP address” or “Internet Protocol address” means the definition presented by wikipedia.org which is “a unique address that certain electronic devices currently use in order to identify and communicate with each other on a computer network utilizing the Internet Protocol standard (IP)—in simpler terms, a computer address.”

### Parameters

In one embodiment, the following parameters are defined for the Filter's 23 Index function:
IW Inappropriate words. This is a list that contains the words defined as inappropriate in the criterion 62 together with a float value from 0 to 1 that characterizes the degree of the inappropriateness.
IS Inappropriate sources (IPs) list together with a float value from 0 to 1 which scale characterizes the degree of inappropriateness.
AM Adjustment matrix. This contains additional coefficients which allow the result adjustment; for instance, an adjustment based on Internet Activity direction (incoming or outgoing), media type, and communications type.
SM Size adjustment matrix. This adjusts appropriateness value for each sample based on content size.
C Reaction map. This coefficient regulates how fast CFI will grow on a given set of data. The higher C the slower CFI grows. Small C makes more sense for adults in families and trusted workers in companies. This map associates user with his/her appropriateness coefficient.
ICF Algorithm

### Parameters

In one embodiment, the following parameters are defined for the Filter's 23 Index function:
IW Inappropriate words. This is a list that contains the words defined as inappropriate in the criterion 62 together with a float value from 0 to 1 that characterizes the degree of the inappropriateness.
IS Inappropriate sources (IPs) list together with a float value from 0 to 1 which scale characterizes the degree of inappropriateness.
AM Adjustment matrix. This contains additional coefficients which allow the result adjustment; for instance, an adjustment based on Internet Activity direction (incoming or outgoing), media type, and communications type.
SM Size adjustment matrix. This adjusts appropriateness value for each sample based on content size.
C Reaction map. This coefficient regulates how fast CFI will grow on a given set of data. The higher C the slower CFI grows. Small C makes more sense for adults in families and trusted workers in companies. This map associates user with his/her appropriateness coefficient.
ICF Algorithm

In one embodiment, the ICF algorithm is shown below. This version is simplified and optimized for moderate performance. Notation d[XX] where d is one of D means value XX of record d.

```
#define EPS=0.00001;
float result = 0;
vector accumulator;
foreach (D as d)
{float cfi = 0; // max here too?
  foreach (IS as is => val)
  { if ( (d[SIP] == is) or (d[DIP] == is) )
    { cfi = val;  break;}
  }
  foreach (IW as w => val)
  {
    if ((d.Data1 contains w) or (d.Data2 contains w) or
    (d.Data3 contains w))
    {
        cfi = max (cfi, val);
    }
  }
  if(cfi > EPS)
  {
    cfi *= AM[d.CT][d.DIR][d.MT];
    foreach (SM as sm => val)
  {
    if (d.DS > )
    {
      cfi *= val;
    }
  }
}
```

This is a CFI value for one sample of data.

One approach is to sum all such values. In this case CAPDEX value will depend on the period of time it is calculated. Typically CAPDEX for one month will be much larger than CAPDEX for 1 hour. Another approach is calculating CAPDEX for the “worst” time window and returning it as the result for the entire period. The drawback of this method is that downloading inappropriate content slowly won't be detectable. However this is rare scenario in the applications Insider designed for. The second algorithm is shown below:

accumulator.push_back( cfi, timestamp(d) );
accumulator.shift_all_data_not_falling_into_time_window( );
result = max( result, sum(accumulator) );
}

Finally, the result to [0,1) interval is mapped, so low values of result won't affect the final value much, higher values will cause a “jump” in return value and very high values will keep the return value high. This is necessary to eliminate statistical noise, and keep the return value in [0,1) range.

return(1−exp(−0.5*pow(($result/user_coefficient(d)),2)));

To map this result to be more user-friendly one can use round (result*100).

### Applications for the Index

### Monitoring vs Blocking

Unlike many products on the market today, a Filter's 23 primary utility is not to block bad content, but rather to monitor and inspect Internet Activity (or private network activity for that matter) and report inappropriate content occurrences.

In many situations, the monitoring approach is much better than blocking (although there is utility in blocking), because if access is blocked many users can easily get access (such as at an Internet café or friend's house). Blocking is impractical. If a second person knows there is a problem with a the Internet Activity of a first person, he or she can use other methods to solve the problem while maintaining on-going monitoring to see if the situation improves.

An example of information that should be blocked is the information that is being leaked and could cause irreversible damage, such as:
Sending out credit card numbers (by kids), social security numbers or similar information
Sending inappropriate photos and videos to public websites sending out strictly confidential information.
In one embodiment, Filter 23 is able to provide blocking.

With the use of a Filter 23, Internet Activity 14 or Internet behavior is what is being monitored—blocking has no comparable value add.

### User Interface

For a single user, a float value in [0;1] range may appear boring. It would be more appropriate if the value is mapped to three or more ranges (like green, yellow and red in a traffic stoplight) to show threat level. In one embodiment, this mapping could be done with a single map<float, enum range>. In another embodiment, the result could be multiplied by 99 and with the addition of 1 and rounded. In one embodiment, second person 18 is notified that the resulting figure is not a percent at all, but just a score from 1 to 100. In another embodiment, a Index score could be mapped to a range of colors. For instance, all scores from zero to fifty could be green, all scores from fifty-one to eighty could be yellow, and all scores from eighty-one to one hundred could be red.

### Be Positive

In addition to calculating a negative index in one embodiment, it would be also useful in another embodiment to provide some index that will indicate how much approved content was downloaded or sent during a given period of time. This could be presented as an Index, just with different parameters listing good words and good websites.

### When to Calculate the Index

In one embodiment, Index 70 is being calculated at the moment when a user requests it. The benefit of this method is that the changes to parameters P are instantly reflected in the resulting value. However for better performance the values can be precalculated; for instance, they could be calculated once a day or calculated on-the-fly, when the parser is processing content.

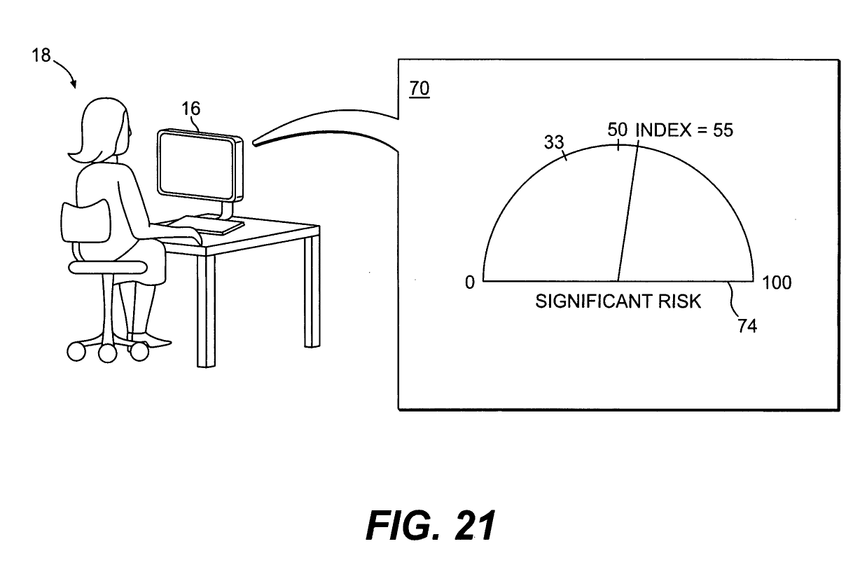

FIG. 21 shows a Second Person 18 on their Information Appliance 16 viewing an Index 70. This FIG. 21 shows one embodiment of an Index 70, which is a graphic representation of a speedometer 74. The graduated scale is from zero to one hundred. In this FIG. 21, an Index 70 equals 55, and the indication at the bottom is “significant risk.”

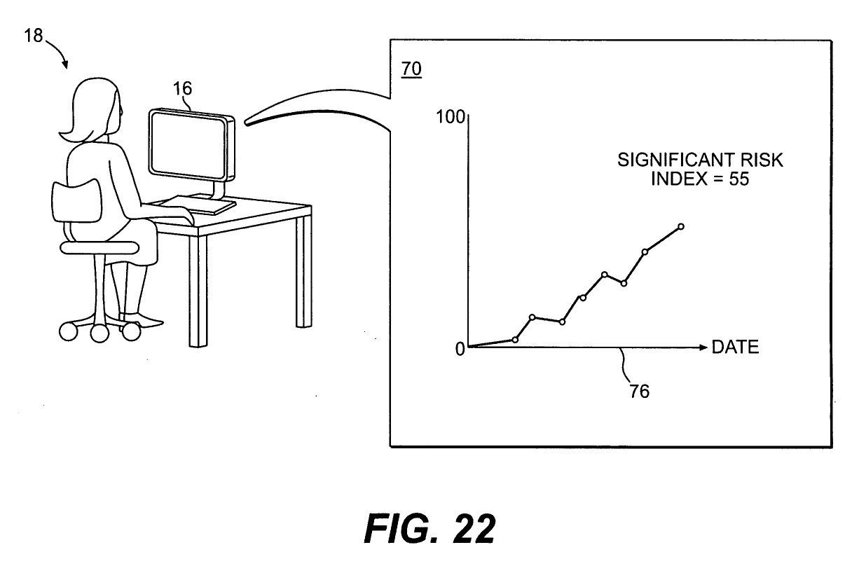

FIG. 22 shows a Second Person 18 on their Information Appliance 16 viewing an Index 70. This FIG. 22 shows one embodiment of an Index 70, which is a graph 76 of an Index as it changes over time. The graduated scale is from zero to one hundred. In this FIG. 22, Index 70 equals 55 and the indication is “significant risk.”

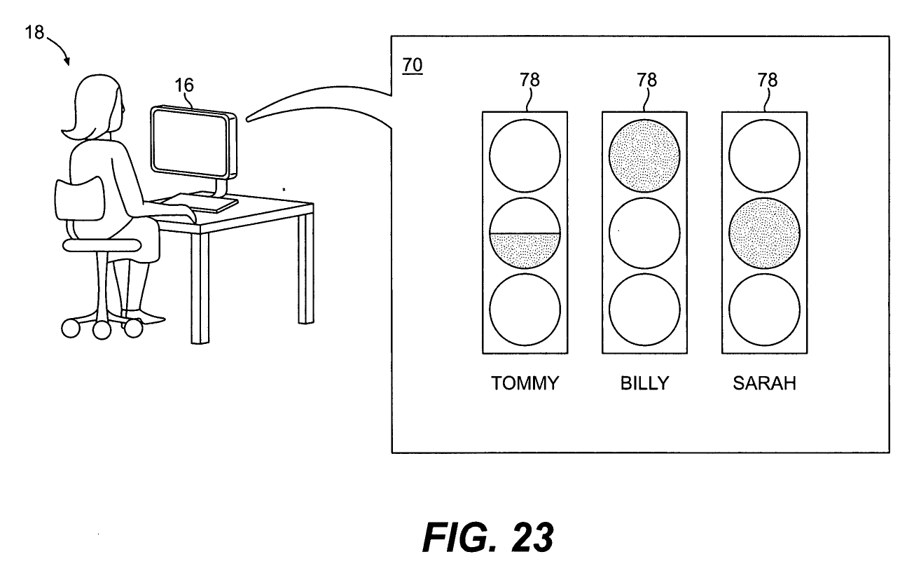

FIG. 23 shows a Second Person 18 on their Information Appliance 16 simultaneously viewing Indices 70 for a plurality of Internet 28 users. This FIG. 23 shows one embodiment of viewing said plurality, which is a traffic stop-light 78 per user. The stop-light for Tommy is half yellow. The stop-light for Billy is red. The stop-light for Sarah is completely yellow. If these Internet 28 users are siblings and if the Second Person 18 is their parent, then the parent could investigate this Internet Activity 14 and intervene if necessary.

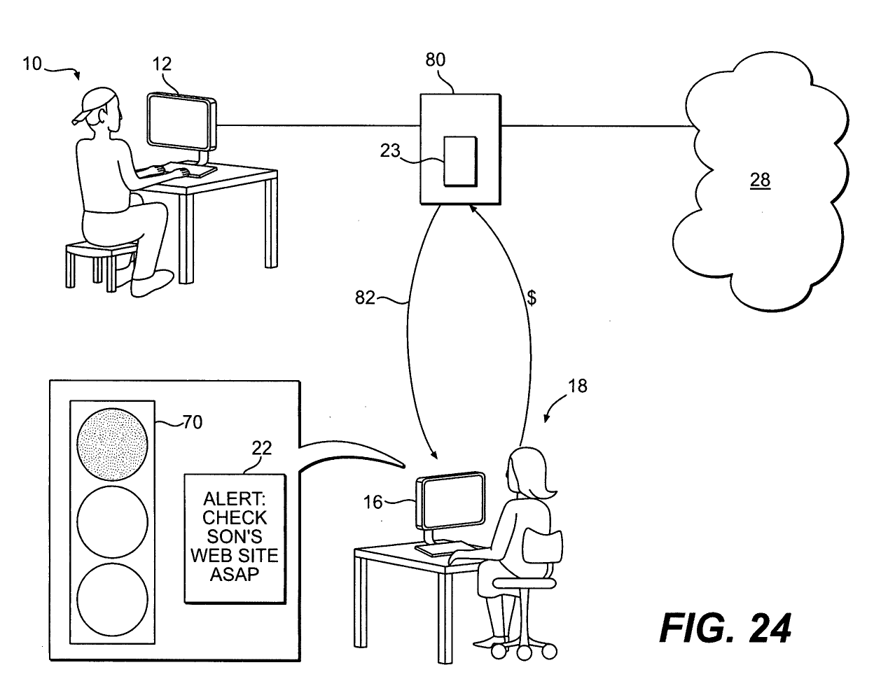

FIG. 24 shows a First Person 10 using a First Person's Information Appliance 12, which is connected to an Internet 28 through an ISP 80. A Second Person 18 is paying said ISP money in exchange for receiving first person activity reports 82, which are sent to Second Person's Information Appliance 16. This FIG. 24 shows one embodiment of first person activity reports 82, which are Alerts 22 and Indices 70.

Parents should have the legal right to monitor and watch all Internet traffic pertaining to their children. Parents are willing to pay money to companies, such as ISPs, who are in possession of this information.

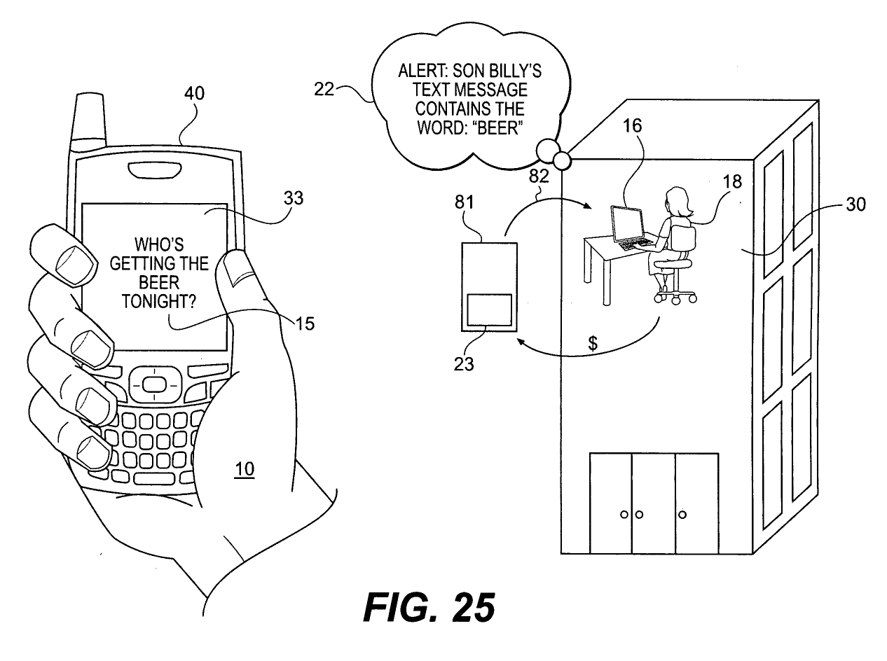

FIG. 25 shows a First Person 10 using a First Person's Information Appliance 12, a cell phone 40, which has Internet Activity 14, a text message 15. In this/Specification and in the Claims that follow, the term “text message” means the definition by wikipedia.org, which is “Short Message Service (SMS), often called text messaging, is a means of sending short messages to and from mobile phones.” A Second Person 18 is at a place of work 30 using a Second Person's Information Appliance 16. A Second Person 18 is paying a telecommunications service provider 81 money in exchange for receiving first person activity reports 82 regarding text message activity 15 occurring on a cell phone 40 used by a First Person 10. In this embodiment, First Person 10 is Billy and is son of Second Person 18. This FIG. 24 shows one embodiment of first person activity reports 82, which is an Alert 22 that reads: “Alert: Son Billy's text message contains the word “beer.”” Second Person 18 judges this text message activity 15 to be inappropriate 33.

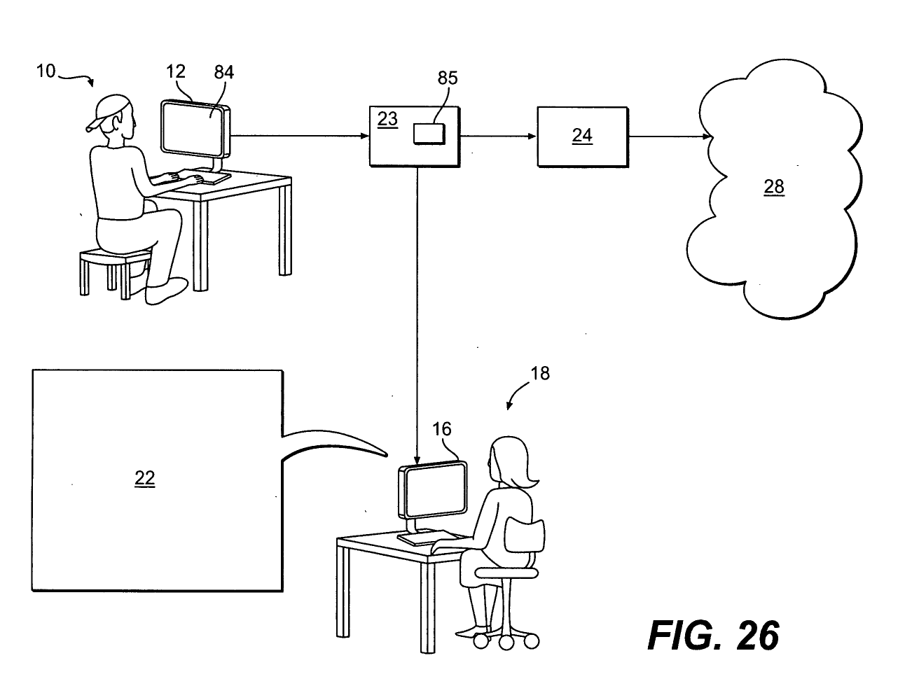

FIG. 26 shows a First Person 10 on a First Person's Information Appliance 12 that is equipped with an Anonymizer 84.

In this Specification and in the Claims that follow, the term “Anonymizer” means the process of using an “Anonymous Proxy Server,” which is defined by wikipedia.org as “routing communications between your computer and the Internet that can hide or mask your unique IP address . . . ”

Prior to employing an Anonymizer 84, a Networking Device 24 could be used to prevent or block a First Person's Information Appliance 12 from accessing a target Internet resource. In FIG. 26, First Person 10 could utilize an Anonymizer 84 to hide or masque First Person's Information Appliance's 12 IP address. By hiding or masquing the IP address, Networking Device 24 would be unable to block First Person's 10 access to the target Internet resource.

In this FIG. 26, a Filter 23 is installed with a de-Anonymizer 85, which is able to detect Anonymized traffic and report on Internet Activity 14. Electronic traffic traveling across a network from First Person's Information Appliance 12 through a Filter 23 and a networking device 24 to an Internet 28 and back is unaffected. Filter 23 sends Alert 22, so Second Person 18 is able to achieve their Internet Activity 14 monitoring objectives, even with traffic that has been made anonymous by an Anonymizer 84.

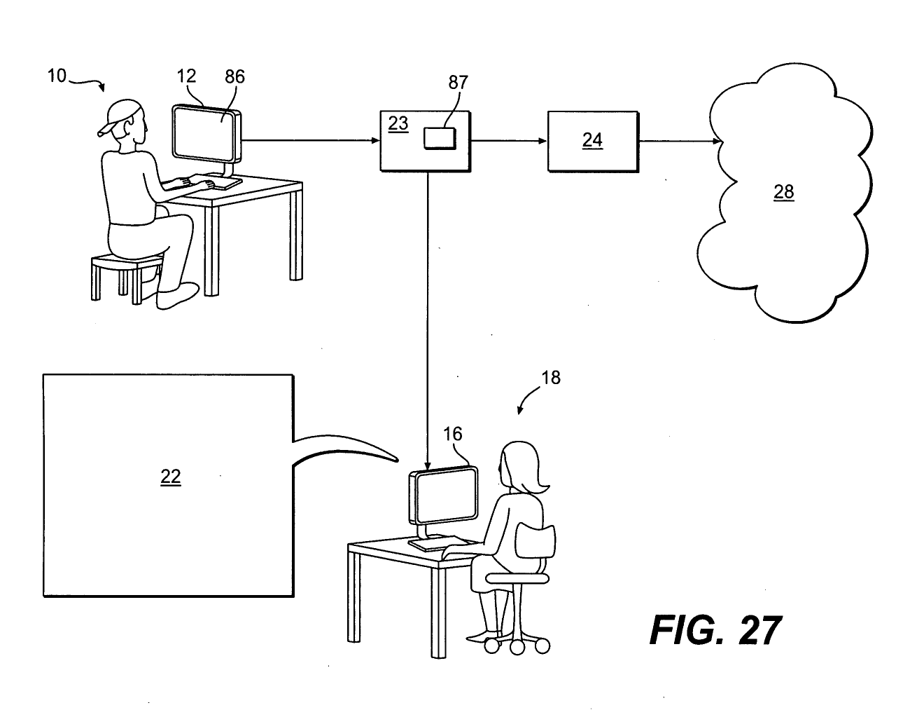

FIG. 27 shows a First Person 10 on a First Person's Information Appliance 12 that is equipped with protocol tunneling 86. In this Specification and in the Claims that follow, the term “protocol tunneling” means any method of using a protocol transmission to mask the transmission of a different protocol within another protocol. A Filter 23 is equipped to with a protocol tunnel reader 87. In this Specification and in the Claims that follow, a “protocol tunnel reader” is any method to read a different protocol that is hidden within the transmission of another protocol. A protocol tunnel reader 87 can read traffic that is within a protocol tunnel 87. Electronic traffic traveling across a network from First Person's Information Appliance 12 through a Filter 23 and a networking device 24 to an Internet 28 and back is unaffected. A Filter 23 sends traffic to a Second Person 18 on their Information Appliance 16, which includes an Alert 22.

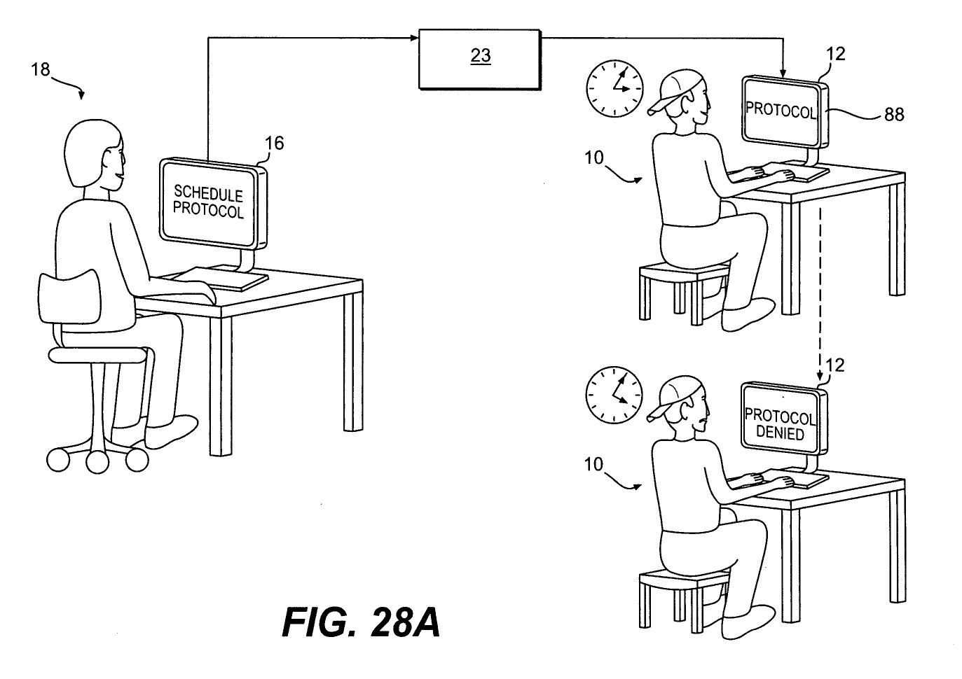

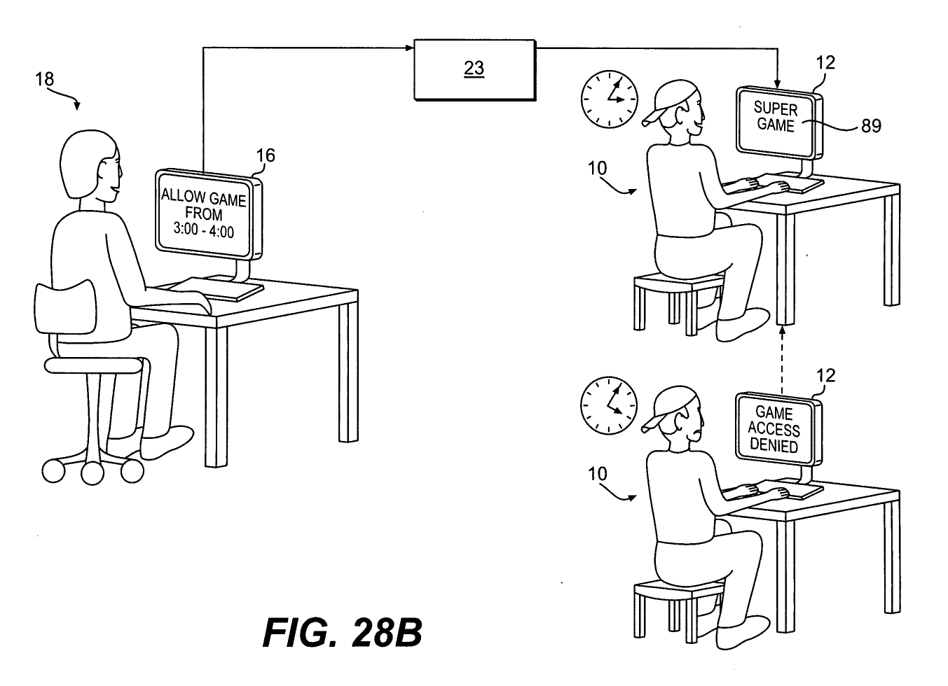

FIG. 28 consists of FIGS. 28A and 28B. FIG. 28A shows a First Person's Information Appliance 12 and Second Person's Information Appliance 16 connected to a Filter 23. Second Person 18, using Second Person's Information Appliance 16, schedules when a protocol 88 can transmit to First Person's Information Appliance 12. In this Specification and the claims that follow, “protocol” is defined by webopedia.org as “An agreed-upon format for transmitting data between two devices.” In this embodiment, the clock reads 3:05 and Protocol 88 on First Person's Information Appliance 12 is transmitting and works. When the clock reads 4:05, Protocol 88 is denied access to a First Person 10 who is using a First Person's Information Appliance 12. Second Persons 18, whether they are parents or employers, can determine through scheduling what protocol transmissions will be allowed to transmit to their children or employees, respectively.

FIG. 28B shows a First Person's Information Appliance 12 and Second Person's Information Appliance 16 connected to a Filter 23. Second Person 18, using Second Person's Information Appliance 16, schedules a time frame where a Video Game 89 running on First Person's Information Appliance 12 will work or will not work according to a time frame. In this embodiment, the clock reads 3:05 and Video Game 89 on First Person's Information Appliance 12 works. When the clock reads 4:05, Video Game 89 does not work on First Person's Information Appliance 12, which reads “Game access denied.” A video game is an example of a specific protocol transmission. Parents are able to control the computer game usage of their children.

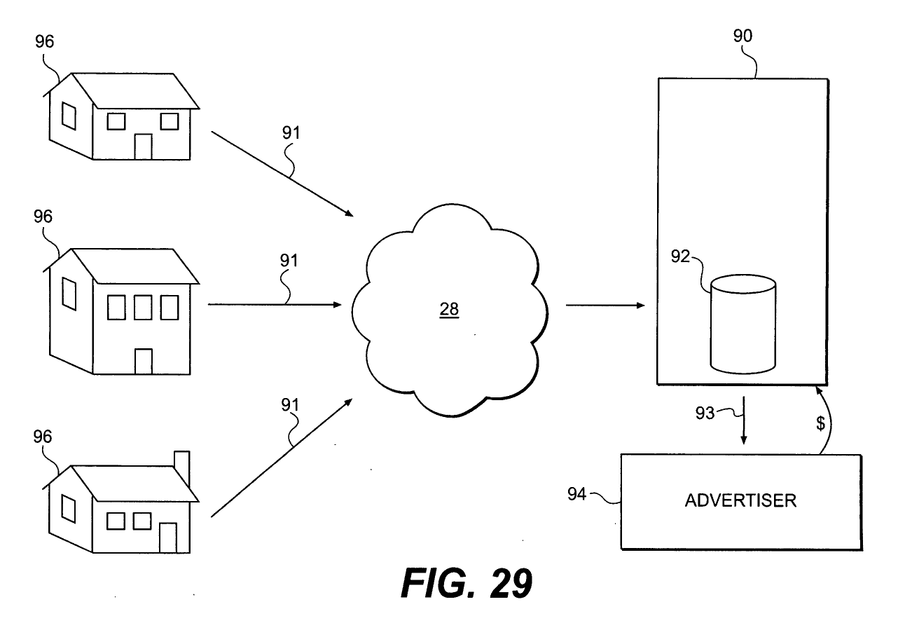

FIG. 29 shows a plurality of houses 96 that use a Filter 23 on their network, which is connected to an Internet 28. Said Filter 23 is transmitting Data 91, including regarding Internet Activity 14, through a Filter 23 over an Internet 28 to a Service Provider 90 and back; in this FIG. 29, said Service Provider 90 has a database 92 that understands said Filter 23. An Advertiser 94 pays money to said Service Provider 90 in exchange for Aggregated Internet Activity 93 from a plurality of homes. All homes should have a Filter 23. Service Providers 90 could give to homes a Filter 23 for free in exchange for the ability to sell Aggregated Internet Activity 93 to Advertisers 94.

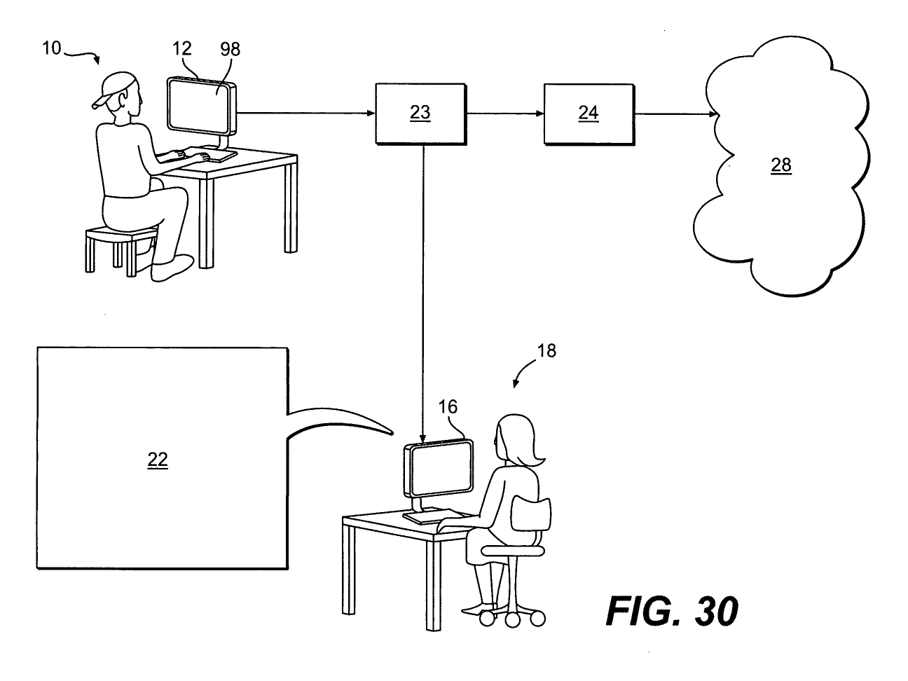

FIG. 30 shows a First Person 10 on a First Person's Information Appliance 12 and a Second Person 18 on a Second Person's Information Appliance 16. Both Information Appliances 12 and 16 are connected to a Filter 23. First Person's Information Appliance 12 is connected to an Internet 28 through a Filter 23 and a networking device 24. Electronic traffic travels across a network from First Person's

Information Appliance 12 through a Filter 23 and a networking device 24 to an Internet 28 and back. First Person's Information Appliance is not containing any software to assist a Filter 98. Even though First Person's Information Appliance 12 is not containing any software to assist a Filter 98, Second Person 18 is able to view First Person's 10 Internet Activity 14 and receive Alerts 22. For Filter 23 to work, no software is required to be installed on First Person's Information Appliance 12.

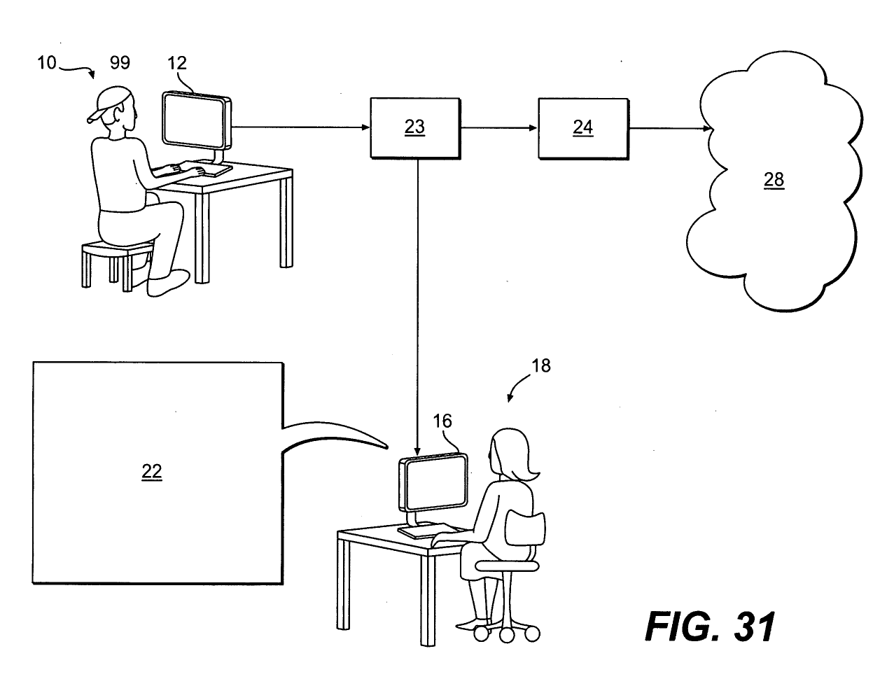

FIG. 31 shows a First Person 10 on a First Person's Information Appliance 12 and a Second Person 18 on a Second Person's Information Appliance 16. Both Information Appliances 12 and 16 are connected to a Filter 23. First Person's Information Appliance 12 is connected to an Internet 28 through a Filter 23 and a networking device 24. Electronic traffic travels across a network from First Person's Information Appliance 12 through a Filter 23 and a networking device 24 to an Internet 28 and back. First Person 10 has no knowledge 99 that a Second Person 18 is monitoring First Person's 10 Internet Activity 14. Second Person 18 is able to view First Person's 10 Internet Activity 14 and receive Alerts 22. For Filter 23 to work and provide monitoring capability for Second Person 18 of First Person's 10 Internet Activity 14, no knowledge 99 of this is required of First Person 10.

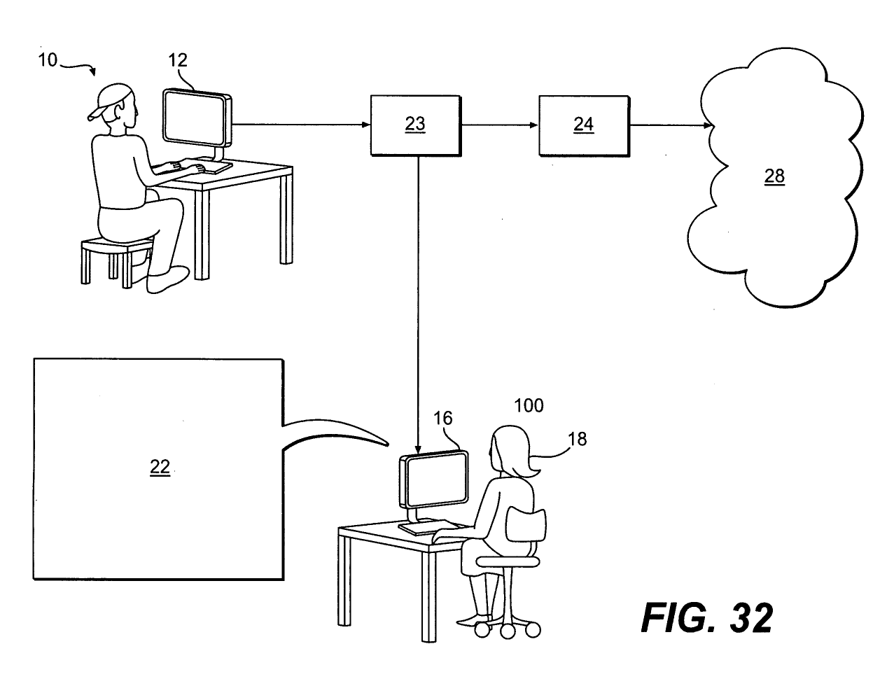

FIG. 32 shows a First Person 10 on a First Person's Information Appliance 12 and a Second Person 18 on a Second Person's Information Appliance 16. Both Information Appliances 12 and 16 are connected to a Filter 23. First Person's Information Appliance 12 is connected to an Internet 28 through a Filter 23 and a networking device 24. Electronic traffic travels across a network from First Person's Information Appliance 12 through a Filter 23 and a networking device 24 to an Internet 28 and back. Second Person 18 accomplishes an installation of a Filter 23 without having any computer expertise 100. Second Person 18 is able to view First Person's 10 Internet Activity 14 and receive Alerts 22. For Filter 23 to be installed by a Second Person 18, no computer knowledge or expertise is required by Second Person 18. Filter 23 can be installed with the same ease as a VCR.

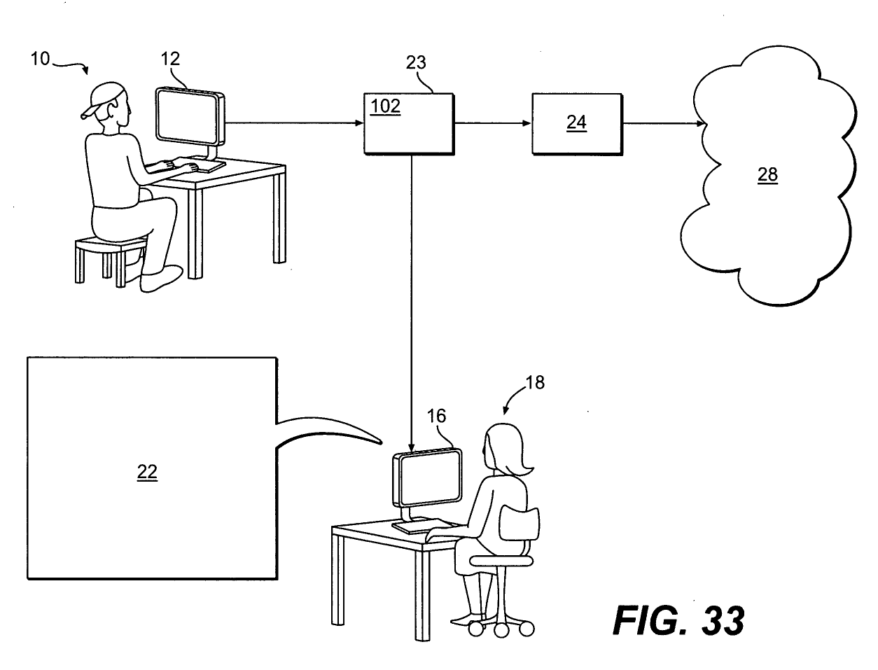

FIG. 33 shows a First Person 10 on First Person's Information Appliance 12 and a Second Person 18 on a Second Person's Information Appliance 16. Both Information Appliances 12 and 16 are connected to a Filter 23. First Person's Information Appliance 12 is connected to an Internet 28 through a Filter 23 and a networking device 24. Electronic traffic travels across a network from First Person's Information Appliance 12 through a Filter 23 and a networking device 24 to an Internet 28 and back. Said Filter 23 requires no configuration 102. A person simply connects it to a First Person's Information Appliance 12 and networking device 24, and Filter 23 works without any configuration 102. Second Person 18 is able to view First Person's 10 Internet Activity 18 and receive Alerts 22. For Filter 23 to work, no configuration is required of Filter 23.

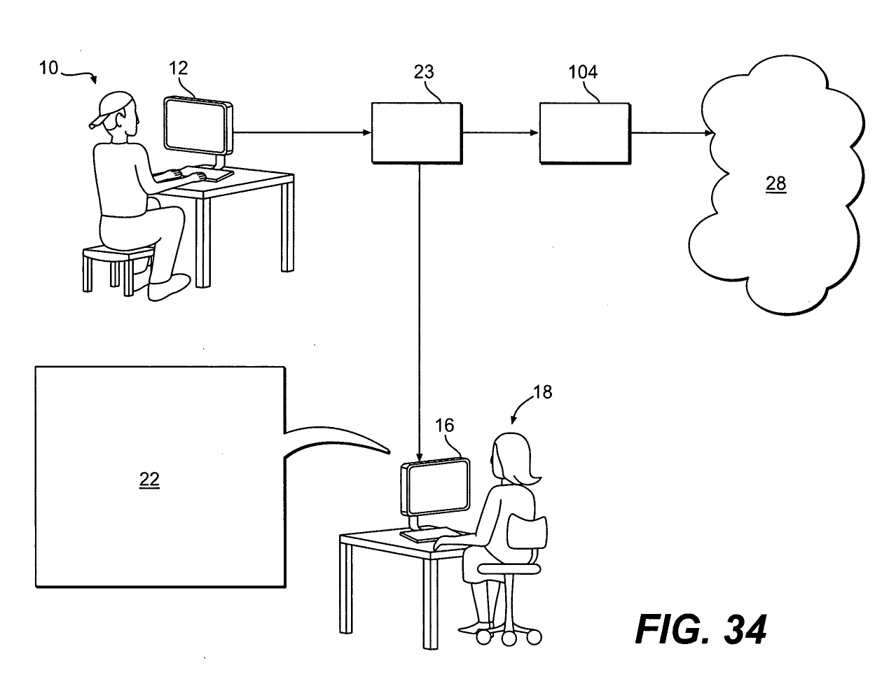

FIG. 34 shows a First Person 10 on a First Person's Information Appliance 12 and a Second Person 18 on a Second Person's Information Appliance 16. Both Information Appliances 12 and 16 are connected to a Filter 23. First Person's Information Appliance 12 is connected to an Internet 28 through a Filter 23 and a networking device 104. Electronic traffic travels across a network from First Person's Information Appliance 12 through a Filter 23 and a networking device 104 to an Internet 28 and back. Said networking device 104 requires no configuration in order for Filter 23 to work. A person simply connects it to a First Person's Information Appliance 12 and a networking device 104, and a Filter 23 works without any networking device configuration. Second Person 18 is able to view First Person's 10 Internet Activity 14 and receive Alerts 22. For Filter 23 to work, no configuration is required of any networking device.

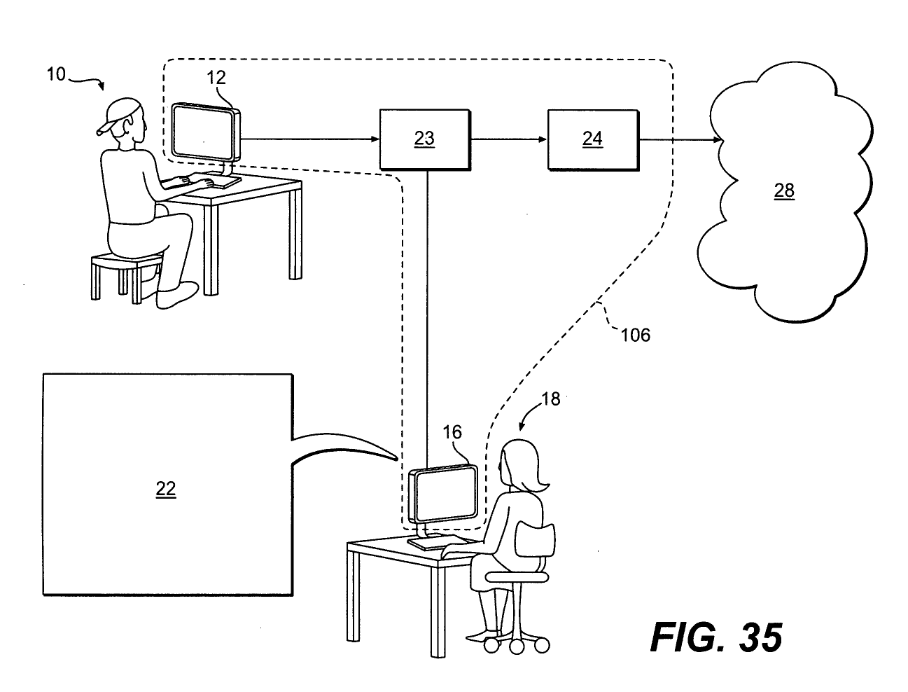

FIG. 35 shows an End-to-End Environment 106 from a First Person's Information Appliance 12 to and including a networking device 24 and a Second Person's Information Appliance 16, which is connected to a Filter 23. A First Person 10 is on a First Person's Information Appliance 12 and a Second Person 18 is on a Second Person's Information Appliance 16. Both Information Appliances 12 and 16 are connected to a Filter 23. First Person's Information Appliance 12 is connected to an Internet 28 through a Filter 23 and a networking device 24. Electronic traffic travels across a network from First Person's Information Appliance 12 through a Filter 23 and a networking device 24 to an Internet 28 and back. Second Person 18 is able to view First Person's 10 Internet Activity 14 and receive Alerts 22. In this Specification and in the Claims that follow, the term “End-to-End Environment 106” means the complete set of hardware involved in a transmission of data from a First Person's Information Appliance 12 through to a networking device 24, which is the last network element that sends data to an Internet 28, plus any device connected to a Filter 23, and where no software is installed on any hardware device therein in order for said Filter 23 to operate. In an alternative embodiment, a Filter 23 could be used to inspect non Internet network traffic, such as on a private network. An example of such a network is a Bluetooth network. In this specification and the claims that follow, “Bluetooth” means the definition and terms as incorporated by wikipedia.org and as follows: “Bluetooth is an industrial specification for wireless personal area networks (PANs). Bluetooth provides a way to connect and exchange information between devices such as mobile phones, laptops, PCs, printers, digital cameras, and video game consoles over a secure, globally unlicensed short-range radio frequency. The Bluetooth specifications are developed and licensed by the Bluetooth Special Interest Group.”

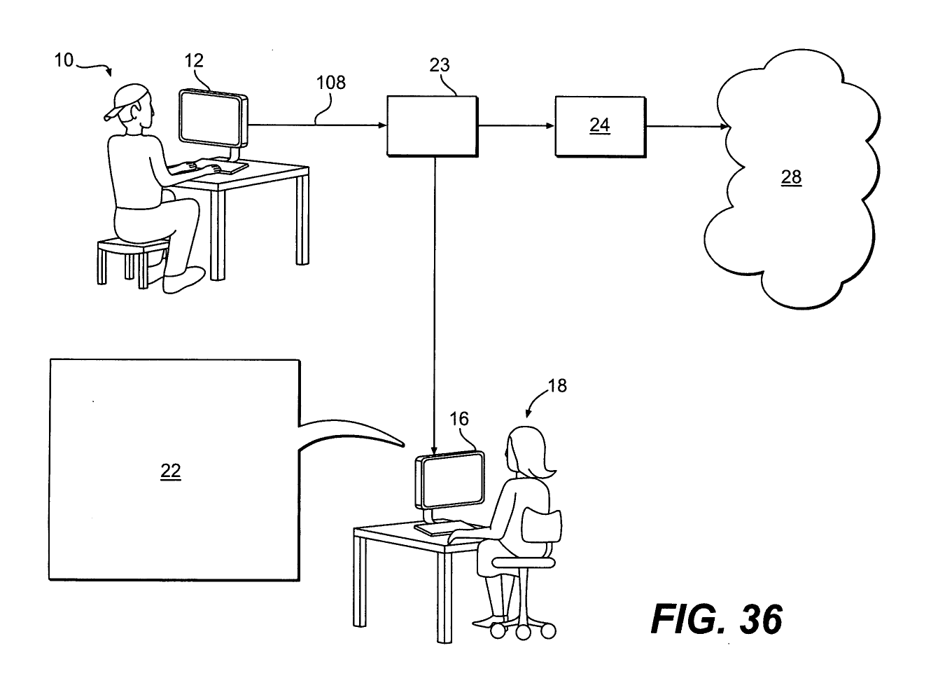

FIG. 36 shows a First Person 10 on First Person's Information Appliance 12 and a Second Person 18 on a Second Person's Information Appliance 16. Both Information Appliances 12 and 16 are connected to a Filter 23. First Person's Information Appliance 12 is connected to an Internet 28 through a Filter 23 and a networking device 24. Electronic traffic travels across a network from First Person's Information Appliance 12 through a Filter 23 and a networking device 24 to an Internet 28 and back. Said Filter 23 performs its function regardless of First Person's Information Appliance Operating System 108. Second Person 18 is able to view First Person's 10 Internet Activity 14 and receive Alerts 22.

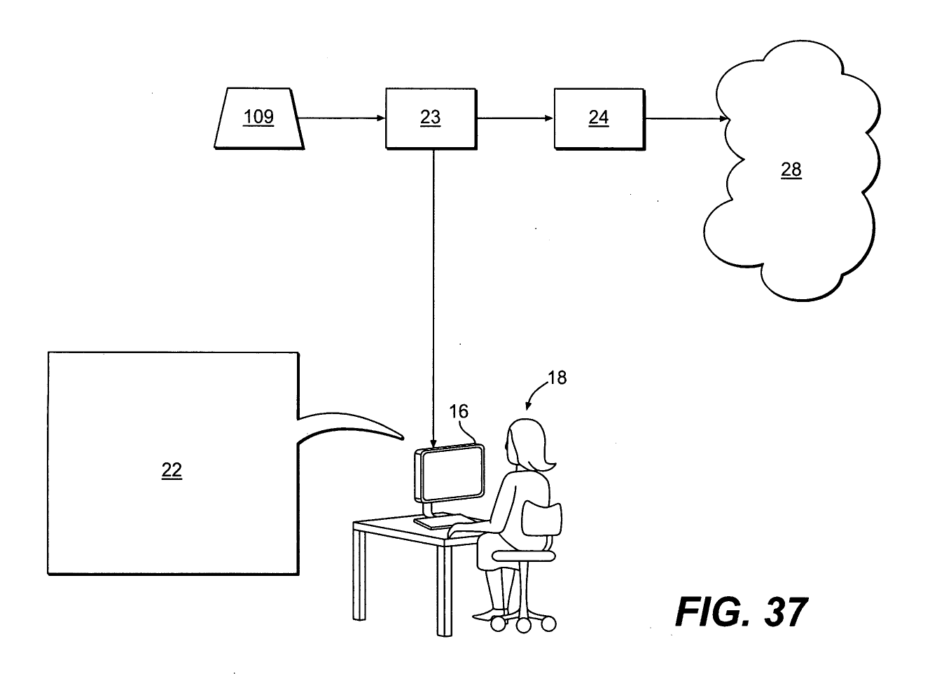

FIG. 37 shows a Device 109. This device 109 is self contained and does not support software installation. An example of such a device 109 is a web enabled refrigerator. Device 109 is connected to the Internet 28 through a Filter 23 and a networking device 24. Electronic traffic travels across a network from Device 109 through a Filter 23 and a networking device 24 to an Internet 28 and back. A Second Person 18 on a Second Person's Information Appliance 16 is able to view Internet Activity 14 from Device 109 and receive Alerts 22 regarding said Internet Activity 14.

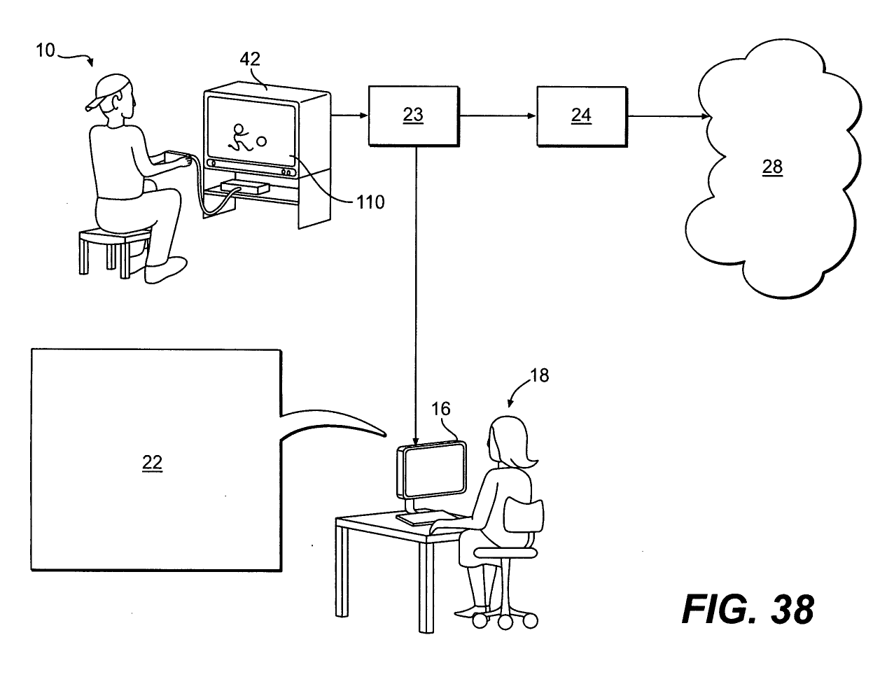

FIG. 38 shows a First Person 10 using a television 42, which is displaying a video game 110 that interacts with an Internet 28. A Second Person 18 is on a Second Person's Information Appliance 16. Said television 42 and Information Appliance 16 are connected to a Filter 23. Television 42 is connected to an Internet 28 through a Filter 23 and a networking device 24. Electronic traffic travels across a network from television 42 through a Filter 23 and a networking device 24 to an Internet 28 and back. Second Person 18 is able to view First Person's 10 Internet Activity 14 and receive Alerts 22.

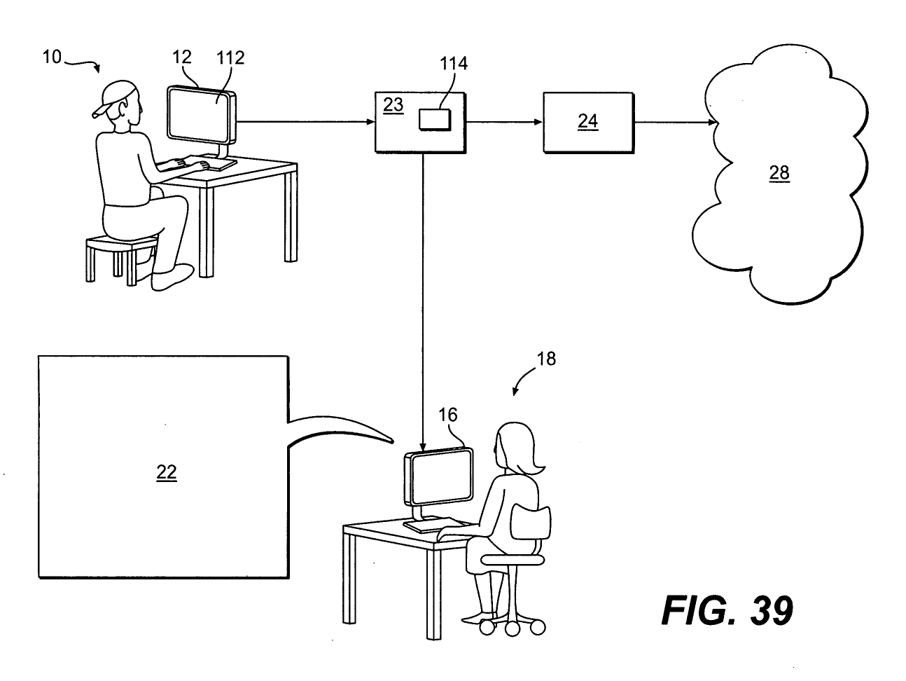

FIG. 39 shows a First Person 10 on a First Person's Information Appliance 12 and a Second Person 18 on a Second Person's Information Appliance 16. Both Information Appliances 12 and 16 are connected to a Filter 23. First Person's Information Appliance 12 is connected to an Internet 28 through a Filter 23 and a networking device 24. Electronic traffic travels across a network from First Person's Information Appliance 12 through a Filter 23 and a networking device 24 to an Internet 28 and back.

Said Filter 23 is equipped with a by-pass method 114. In this Specification and in the Claims that follow, the term “by-pass method” 114 means a method to signal a Filter 23 to not perform its Internet Activity 14 inspecting function, for a designated information appliance. A system administrator would be able to use by-pass method 114 to disable Filter 23 from inspecting Internet Activity 14 of a First Person 10, a chief executive in a business for example or a parent as another example.

In FIG. 39, First Person's Information Appliance can be equipped with a by-pass method 114 prevention method 112. In this Specification and in the Claims that follow, the term ““by-pass method 114” prevention method” 112 means a method to recognize signals of by-pass method 114, to disavow such signals, and to continue to inspect Internet Activity 14 for a designated information appliance. Second Person 18 is able to view First Person's 10 Internet Activity 14 and receive Alerts 22, notwithstanding the attempted use of by-pass method 114.

By way of example, by-pass method 114 is like a radar detector. A system administrator equips a Filter 23 with a by-pass method 114 (or a radar detector) so a chief executive can avoid having his Internet Activity 14 inspected (or avoid being stopped for speeding because of the radar detector). However, an information appliance can be equipped with a “by-pass method 114” prevention method (like a “radar detector” detector) such that the Internet Activity 14 from the designated information appliance is still detected and inspected.

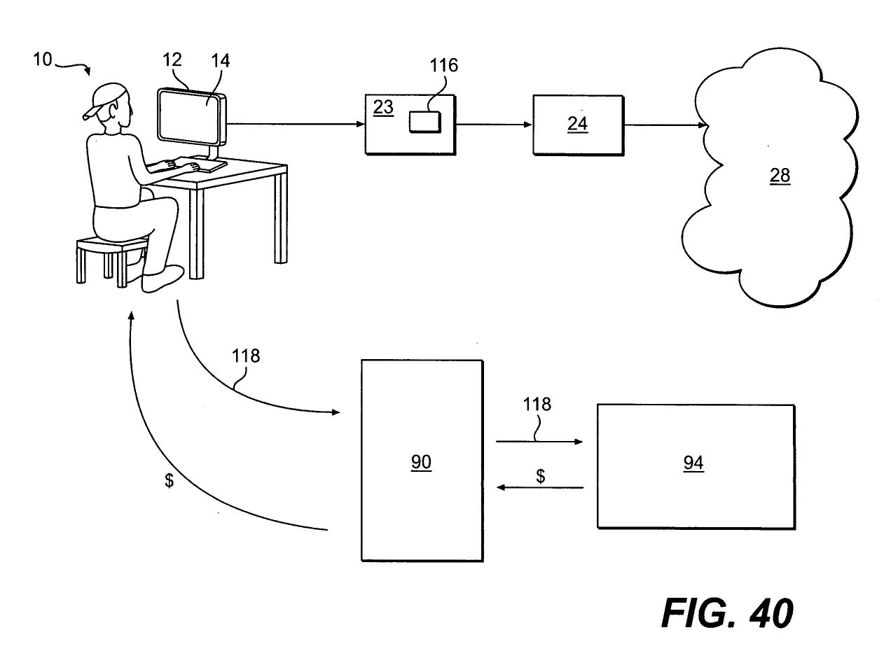

FIG. 40 shows a First Person 10 using a First Person's Information Appliance 12, which is connected to a Filter 23. Filter 23 is connected to a Networking Device 24, which is connected to an Internet 28. First Person's Information Appliance 12 has Internet Activity 14 occurring. Filter 23 is equipped with a method 116 to track Internet Activity 14 for the purpose to sell Internet Activity 14 that is salient 118 to an advertiser 94. In this Specification and the claims that follow, the term “salient to an advertiser” means important, prominent, or valuable to an advertiser. Examples of such information are: what web sites are visited, how time is spent on-line, what shopping and purchasing preferences, what leisure sites are preferred, what bandwidth is used, and what products and services are being sought and when. First Person 10 sells to a service provider 90 its Internet Activity that is salient 118 in exchange for money. In this specification and the claims that follow, “money” is defined as currency or any other benefit that has value. Service provider 90 aggregates Internet Activity 14 data including Internet Activity that is salient to an advertiser 118 and resells that data to advertisers.

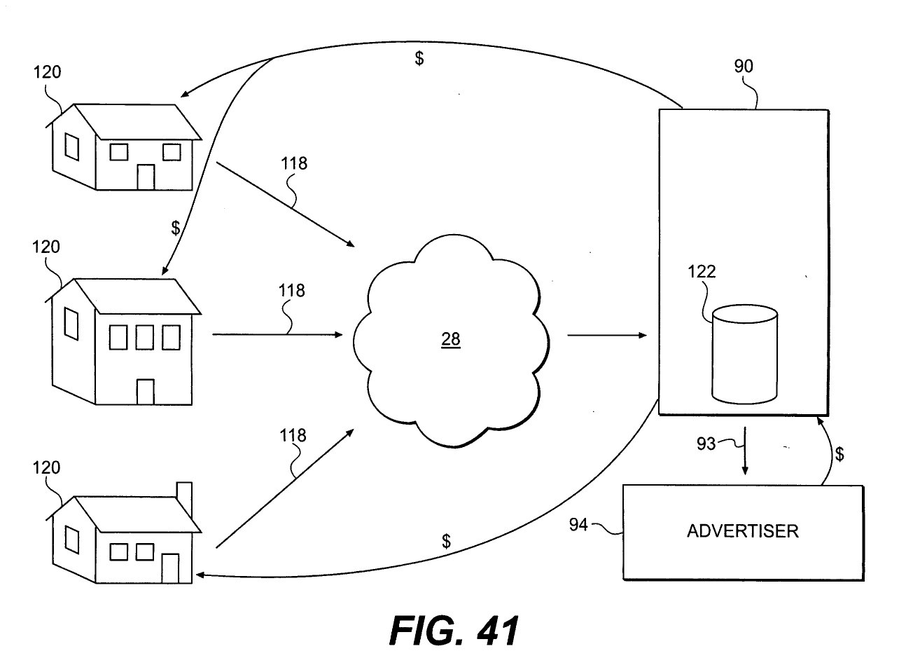

FIG. 41 shows households 120 sending, to a Service Provider 90 through an Internet 28, Internet Activity that is salient to an advertiser 118. Service provider 90 aggregates into a database 122 Internet Activity 14 data including Internet Activity that is salient to an advertiser 118. Service Provider 90 sells to advertisers 94 aggregated data 93 in exchange for money. Service Provider 90 pays money to each household 120 in exchange for the use of its Internet Activity that is salient to an advertiser 118.

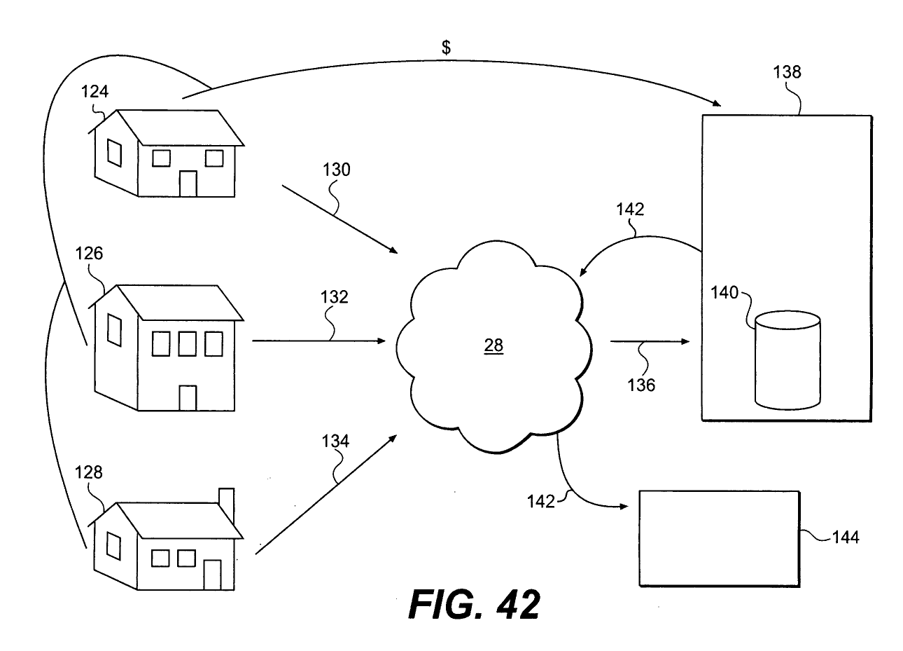

FIG. 42 shows households connected to an Internet 28. A first Household 124 generates first household Internet transactions 130, which are transactions unique to that household. A second household 126 generates second household Internet transactions 132, which are transactions unique to that household. A third household 128 generates third household Internet transactions 134, which are transactions unique to that household. The transactions are sent through an Internet 28 with the intent of eventually reaching an Intended Destination 144, which is the destination for the household Internet transactions to transact. However, each household wishes to have their transactions made anonymous. In this Specification and the claims that follow, the term “transactions made anonymous” means that no financial or attribute data can be tracked to an individual or individual household.” Each household does not wish to use their credit card or name or any identity information whatsoever. Each household does not wish for any web site to have any information available for permanent storage regarding its household. Each household pays money to a Service Provider 138 that makes Internet transactions anonymous 142. One embodiment of a Service Provider 138 making Internet transaction anonymous 142 is when web sites require information pertaining to a household such as a credit card, an address, or a name, for example, Service Provider 138 provides anonymous information so that a web site cannot track a transaction to a household. Another embodiment is Service Provider 138 negotiates with ISPs and web sites on behalf of its customers that no data will be utilized without permission of the customer or Service Provider 138, whatever the case calls for. Internet transactions 136 coming from households come to Service Provider 138 via an Internet 28. Household Internet transactions made anonymous 142 go from Service Provider 138 to the Intended Destination 144, through an Internet 28. At the Intended Destination 144 household Internet transactions 130, 132, and 134 are able to transact.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing an Internet Activity Evaluation System that have been disclosed above are intended to educate the reader about preferred embodiments of the invention, and are not intended to constrain the limits of the invention or the scope of Claims.

### LIST OF REFERENCE CHARACTERS

10 First Person
12 First Person's Information Appliance
14 Internet Activity
15 Text Message Activity
16 Second Person's Information Appliance
18 Second Person
20 Home
22 Alert
23 Filter
24 Networking Device
26 Wall Jack
28 Internet
30 Place of Work
32 Internet Activity judged to be inappropriate
33 Text Message judged to be inappropriate
36 Computer
38 PDA
40 Cell Phone
42 TV that is enabled to send data on an Internet
44 Modem
46 Router
47 Networking Switch
48 Local Area Network Connection
49 Local Area Network
50 Combination of a Modem and a Filter in one unit
52 Combination of a Router and a Filter in one unit
54 Combination of a Modem, Router, and Filter in one unit
55 Combination of a Filter and a Switch in one unit
56 Software Functional Diagram of Filter 23
57 Copy of all traffic on the network
58 Traffic generated by Filter 23 being sent onto network
59 User Interface of Filter 23
60 Panorama of representations of web sites visited
62 Criterion for judging inappropriate material
64 Web Mail
66 Encrypted Traffic
68 Decrypted Traffic
70 Index
72 Rendering of an Index as a Traffic Stoplight
74 Rendering of an Index as an Automobile Speedometer
76 Rendering of an Index as a Graph over time
78 Rendering of an Index per user for a plurality of users at one time
80 Internet Service Provider (ISP)
81 Telecommunications Service Provider
82 First person activity reports
84 Anonymizer
85 de-Anonymizer
86 First Person's Computer equipped with Protocol Tunneling
87 Filter equipped with a protocol tunnel reader
88 Protocol transmission
89 Video game
90 Service Provider that aggregates Internet activity 14 data
91 Data from Filter 23 regarding Internet Activity 14
92 Database that interacts with Filter 23
93 Aggregated from a plurality of households Internet Activity that is salient to an advertiser
94 Advertiser
96 House which utilizes a Filter 23 on its network
98 First Person's Information Appliance which does not contain any software to assist a Filter
99 First Person who has no knowledge that Second Person is inspecting First Person's Internet Activity
100 Second person who has no special computer expertise
102 Filter which requires no configuration
104 Networking device which requires no configuration in order to operate a Filter
106 Complete set of hardware involved in a transmission of data from a First Person's Information Appliance through to a Second Person's Information Appliance through a Filter, where no software is installed on any hardware device therein in order for said Filter to operate.
108 Filter that performs its function regardless of First Person's Information Appliance operating system
109 Internet enabled device that is self contained and does not support software installation such as a refrigerator
110 Video game that interacts with the Internet
112 A method for Filter 23 to recognize and prevent a bypass method 114 from preventing a Filter 23 from performing its function
114 A method to bypass (or turn off) a Filter 23 from inspecting Internet activity of a designated information appliance
116 A method to track Internet Activity for the purpose to resell Internet Activity salient to an advertiser
118 Internet Activity salient to an advertiser
120 A household
122 A database that aggregates for many households Internet Activity salient to an advertiser
124 Household Smith
126 Household Jones
128 Household Ryan
130 Internet transactions Smith
132 Internet transactions Jones
134 Internet transactions Ryan
136 Household Internet transactions from Internet to a service provider
138 Service Provider that makes any Internet transaction anonymous
140 Database that tracks anonymous variable to actual Internet transaction owner
142 Internet transactions made anonymous 138
144 Intended Destination for household Internet transactions

What is claimed is:

1. A method comprising the steps of:
using a first information appliance (12); said first information appliance (12) being used by a first person (10);
connecting said first information appliance (12) to the Internet (28); and
inspecting an Internet activity (14) performed on said first information appliance (12);
said step of inspecting Internet activity (14) being enabled by an installation of a Filter (23) in said home by said second person (18);
said installation being performed by a second person (18) without special computer expertise (100);
said installation being completed without any associated installation software being installed on said first information appliance (98);
said Filter (23) being installed between said first information appliance (12) and a wall jack (26) used for said Internet (28) connection by said first person (10);
said Filter (23) being controlled by said second person (18);
said first information appliance (12) and said Filter (23) being located in a home where both said first person (10) and said second person (12) reside;
said Filter (23) showing said first person's (10) said Internet activity (14) without said second person (18) having access to said first information appliance (12).

2. A method as recited in claim 1, in which said Internet activity (14) includes email.

3. A method as recited in claim 1, in which said Internet activity (14) includes web-mail (64).

4. A method as recited in claim 1, in which said Internet activity (14) includes viewing a plurality of web pages.

5. A method as recited in claim 1, in which said Internet activity (14) includes viewing pornography.

6. A method as recited in claim 1, in which said Internet activity (14) includes using a social networking web site.

7. A method as recited in claim 1, in which said Internet activity (14) includes using instant messaging.

8. A method as recited in claim 1, in which said Internet activity (14) includes using voice over Internet Protocol (VOIP).

9. A method as recited in claim 1, in which said Internet activity (14) includes viewing a message from a chat room.

10. A method as recited in claim 1, in which said Internet activity (14) is encrypted (66).

11. A method as recited in claim 1, in which said first information appliance (12) is a computer (36).

12. A method as recited in claim 1, in which said first information appliance (12) is a personal digital assistant (38).

13. A method as recited in claim 1, in which said first information appliance (12) is a phone.

14. A method as recited in claim 1, in which said first information appliance (12) is a television (42).

15. A method as recited in claim 1, in which said first information appliance (12) is an Internet (28) enabled device (109).

16. A method as recited in claim 1, in which said first information appliance (12) is a video game (89).

17. A method as recited in claim 1, in which said first person (10) is a child and said second person (18) is a parent of said child.

18. A method as recited in claim 1, in which said first person (10) is a husband and said second person (18) is a wife of said husband.

19. A method as recited in claim 1, in which the step of inspecting said Internet activity (14) by said second person (18) is conducted on data that has been filtered and reduced from its original version.

20. A method as recited in claim 1, in which the step of inspecting said Internet activity (14) by said second person (18) is conducted on a password protected web site.

21. A method as recited in claim 1, in which the step of inspecting said Internet activity (14) by said second person (18) is performed by said second person (18) viewing a panorama (60); said panorama (60) containing representations of a plurality of web pages visited.

22. A method as recited in claim 1, in which the step of inspecting said Internet activity (14) by said second person (18) is conducted by viewing an Index (70).

23. A method as recited in claim 1, in which said Internet activity (14) contains activity judged to be inappropriate (32); and a criterion (62) for inappropriateness is determined by said second person (18).

24. A method as recited in claim 1, further comprising the step of:
receiving an alert (22) when said Internet activity (14) contains inappropriate activity (32); said alert (22) being received by said second person (18).

25. A method as recited in claim 24, in which said alert (22) is received on a second person's information appliance (16).

26. A method as recited in claim 25, in which said second person's information appliance (16) is a computer (36).

27. A method as recited in claim 25, in which said second person's information appliance (16) is a PDA (38).

28. A method as recited in claim 25, in which said second person's information appliance (16) is a cell phone (40).

29. A method as recited in claim 25, in which said alert (22) is received as an e-mail message.

30. A method as recited in claim 25, in which said alert (22) is received as a text message (15).

31. A method as recited in claim 1, in which said Filter (23) requires no configuration (102).

32. A method as recited in claim 1, in which said Filter (23) enables said inspection of Internet Activity (14) without the need for a device on the network to be reconfigured (104).

33. A method as recited in claim 1, in which said Filter (23) enables said inspection of Internet Activity (14) without the need for software to be installed on a device on a network (106).

34. A method as recited in claim 1, in which said Filter (23) enables said inspection of Internet activity (14) without the need to know said first person's information appliance (12) operating system (108).

35. A method as recited in claim 1, in which said Filter (23) enables said inspection of Internet activity (14) without first person (10) having knowledge (99) that second person (18) is conducting said inspection of first person's (10) Internet activity (14).

36. A method comprising the steps of:
using a first information appliance (12); said first information appliance (12) being used by a first person (10);
connecting said first information appliance (12) to the Internet (28); and
inspecting Internet activity (14) performed on said first information appliance (12);
said inspection of said Internet activity (14) conducted on said first information appliance (12) being performed by a second person (18);
said Internet activity (14) inspection being enabled by installation of a Filter (23) by said second person (18);
said installation being performed without special computer expertise (100);
said Filter (23) connected to a network between said first information appliance (12) and said Internet (28);
said Filter (23) installation being completed and said Filter (23) showing said first person's (10) said Internet activity (14) without said second person (18) having access to said first information appliance (12);
said inspection of said Internet activity (14) by said second person (18) is conducted on data that has been filtered and reduced from its original version without special computer expertise (100).
said Filter (23) enables said second person (18) to establish a criterion (62) without special computer expertise (100); said criterion (62) is used to render judgment regarding the appropriateness (32) of said Internet activity (14).

37. A method as recited in claim 36, in which said Internet activity (14) includes email.

38. A method as recited in claim 36, in which said Internet activity (14) includes web-mail (64).

39. A method as recited in claim 36, in which said Internet activity (14) includes viewing a plurality of web pages.

40. A method as recited in claim 36, in which said Internet activity (14) includes using instant messaging.

41. A method as recited in claim 36, in which said Internet activity (14) includes using voice over Internet Protocol (VOIP).

42. A method as recited in claim 36, in which said Internet activity (14) is encrypted (66).

43. A method as recited in claim 36, in which said first information appliance (12) is a computer (36).

44. A method as recited in claim 36, in which said first information appliance (12) is a personal digital assistant (38).

45. A method as recited in claim 36, in which said first person (10) is a child and said second person (18) is a parent of said child.

46. A method as recited in claim 36, in which said first person (10) is an employee and said second person (18) is an employer of said employee.

47. A method as recited in claim 36, in which the step of inspecting said Internet activity (14) by said second person (18) is conducted on a password protected web site.

48. A method as recited in claim 36, in which the step of inspecting said Internet activity (14) by said second person (18) is performed by said second person (18) viewing a panorama (60); said panorama (60) containing a representation of a plurality of web pages visited.

49. A method as recited in claim 36, in which the step of inspecting said Internet activity (14) by said second person (18) is conducted by assigning an Index (70).

50. A method as recited in claim 49, in which said Index (70) is a rendering of a traffic stoplight (72).

51. A method as recited in claim 49, in which said Index (70) is a rendering of an automobile speedometer (74).

52. A method as recited in claim 49, in which said Index (70) is a rendering of an Index as a graph of said Index (70) over time (76).

53. A method as recited in claim 36, in which said criterion (62) for inappropriateness is determined using said first person's job description.

54. A method as recited in claim 36, further comprising the step of:
receiving an alert (22) when said Internet activity (14) contains inappropriate activity (32); said alert (22) being received by said second person (18).

55. A method as recited in claim 54, in which said alert (22) is received on a second person's information appliance (16).

56. A method comprising the steps of:
using a first information appliance (12); said first information appliance (12) being used by a first person (10);
connecting said first information appliance (12) to the Internet (28); and
combining a Filter (23) with a networking device (24) into one combination unit (50);
inspecting Internet activity (14) performed on said first information appliance (12);
said Internet activity (14) inspection being enabled by an installation of said combination unit (50);
said installation being performed by a second person (18) without special computer expertise (100);
said Internet activity (14) inspection being performed by a second person (18) without special computer expertise (100);
said combination unit (50) being installed between said first information appliance (12) and said Internet (28) connection.

57. A method as recited in claim (56), in which said networking device (24) is a modem (44).

58. A method comprising the steps of:
using a first information appliance (12); said first information appliance (12) being used by a first person (10);
connecting said first information appliance (12) to the Internet (28); and
combining a Filter (23) with a router (46) into one combination unit (52);
inspecting said Internet activity (14) performed on said first information appliance (12);
said Internet activity (14) inspection being enabled by an installation of said combination unit (52);
said installation being performed by a second person (18) without special computer expertise (100);
said Internet activity (14) inspection being performed by a second person (18) without special computer expertise (100);
said combination unit (52) being installed between said first information appliance (12) and said Internet (28) connection.

59. A method comprising the steps of:
using a first information appliance (12); said first information appliance (12) being used by a first person (10);
connecting said first information appliance (12) to the Internet (28); and
combining a Filter (23), a router (46) and a modem (44) into one combination unit (54);
inspecting Internet activity (14) performed on said first information appliance (12);
said Internet activity (14) inspection being enabled by an installation of said combination unit (54);
said installation being performed by a second person (18) without special computer expertise (100);
said Internet activity (14) inspection being performed by a second person (18) without special computer expertise (100);
said combination unit (54) being installed between said first information appliance (12) and said Internet (28) connection.

60. A method comprising the steps of:
using a first information appliance (12); said first information appliance (12) being used by a first person (10);
connecting said first information appliance (12) to the Internet (28); and
combining a Filter (23) with a networking switch (47) into one combination unit (55);
inspecting Internet activity (14) performed on said first information appliance (12);
said Internet activity (14) inspection being enabled by an installation of said combination unit (55);
said installation being performed by a second person (18) without special computer expertise (100);
said Internet activity (14) inspection being performed by a second person (18) without special computer expertise (100);
said combination unit (55) being installed between said first information appliance (12) and said Internet (28) connection.

61. A method comprising the steps of:
using a first information appliance (12); said first information appliance (12) being used by a first person (10);
connecting said first information appliance (12) to the Internet (28); and
inspecting Internet activity (14) performed on said first information appliance (12);
said inspection of said Internet activity (14) conducted on said first information appliance (12) being performed by a second person (18);
said Internet activity (14) inspection being enabled by use of an Index (70);
said Index (70) being calculated automatically;
said Index (70) calculation being customizable by second person (18) without any special computer expertise (100).

62. A method as recited in claim 61, in which said Index (70) is a rendering of a traffic stoplight (72).

63. A method as recited in claim 61, in which said Index (70) is a rendering of an automobile speedometer (74).

64. A method as recited in claim 61, in which said Index (70) is a rendering of an Index as a graph over time (76).

65. A method comprising the steps of:
using a first information appliance (12); said first information appliance (12) being used by a first person (10);
connecting said first information appliance (12) to the Internet (28); and
inspecting Internet activity (14) performed on said first information appliance (12);
said Internet activity (14) inspection being performed by a second person (18);
said connection to said Internet (28) provided by the Internet Service Provider (80);
said Internet activity (14) inspection being enabled by said Internet Service Provider (80);
said second person (18) pays money to said Internet Service Provider (80) in exchange for viewing said Internet activity (14).

66. A method as recited in claim 65, in which said first person (10) is a child and said second person (18) is a parent of said child.

67. A method as recited in claim 65, in which said Internet activity (14) contains activity judged to be inappropriate (32); and a criterion (62) for inappropriateness is determined by said second person (18).

68. A method as recited in claim 65, further comprising the step of:
receiving an alert (22) when said Internet activity (14) contains inappropriate activity (32); said alert (22) being received by said second person (18).

69. A method as recited in claim 68, in which said alert (22) is received on a second person's information appliance (16).

70. A method as recited in claim 69, in which said second person's information appliance (16) is a computer (36).

71. A method as recited in claim 69, in which said second person's information appliance (16) is a PDA (38).

72. A method as recited in claim 69, in which said second person's information appliance (16) is a cell phone (40).

73. A method as recited in claim 69, in which said alert (22) is received as an e-mail message.

74. A method as recited in claim 69, in which said alert (22) is received as a text message.

75. A method as recited in claim 65, in which the step of inspecting said Internet activity (14) by said second person (18) is conducted by viewing an Index (70).

76. A method as recited in claim 75, in which said Index (70) formula is customizable by second person (18) without any special computer expertise (100).

77. A method comprising the steps of:
using a cell phone (40); said cell phone (40) being used by a first person (10);
said cell phone (40) sends and receives text messages (15); and
inspecting said text message activity (15);
said text message activity (15) inspection being performed by a second person (18);
said text messages sent through a Telecommunications Service Provider (81);
said text messaging inspection being enabled by said Telecommunications Service Provider (81);
said second person (18) pays money to said Telecommunications Service Provider (81) in exchange for viewing said text message activity (15).

78. A method as recited in claim 77, in which said text message activity (15) contains activity judged to be inappropriate (33); and a criterion (62) for inappropriateness is determined by said second person (18).

79. A method as recited in claim 78, further comprising the step of:
receiving an alert (22) when said text message activity (15) contains inappropriate activity (33); said alert (22) being received by said second person (18).

80. A method as recited in claim 77, in which the step of inspecting said text message activity (15) by said second person (18) is conducted by viewing an Index (70).

81. A method as recited in claim (80), in which said Index (70) formula is customizable by second person (18) without any special computer expertise (100).

82. A method comprising the steps of:
using a Filter (23); said Filter (23) being installed in a home (96);
tracking substantially all Internet activity (14) from said home (96) using said Filter (23); and
sending a plurality of data (91) regarding said Internet activity (14) using said Filter (23) from said home (96) to a service provider (90);
receiving and analyzing said plurality of data (91) at said service provider (90);
aggregating said plurality of data (91) from a plurality of said homes (96) at said service provider (90); and
providing a plurality of payments from an advertiser (94) to said service provider (90) in exchange for aggregated Internet activity (93) from said plurality of homes (96) having a Filter (23).

83. A method comprising the steps of:
using a first information appliance (12); said first information appliance (12) being used by a first person (10);
connecting said first information appliance (12) to the Internet (28);
said first information appliance (12) being connected to a Filter (23), to a Networking Device (24), and to the Internet (28); and
equipping said Filter (23) to track Internet Activity (14) for selling a plurality of records of Internet Activity that is salient (118) to an advertiser (94);
selling a plurality a records of Internet Activity that is salient (118) to an advertiser (94);
making a first payment from a service provider (90) to a first person (10) in exchange for the right to use said plurality of records of Internet Activity that is salient (118) to an advertiser (94);
aggregating said plurality of records of Internet Activity from a plurality of persons by said service provider (90);
selling said plurality of records Internet Activity (93) which have been aggregated that are salient (118) to an advertiser (94); and
making a second payment from said advertiser (94) to said service provider (90) in exchange for the right to use said plurality of records of Internet Activity which have been aggregated that is salient (118) to an advertiser (94).

84. A method comprising the steps of:
enabling access to the Internet (28) to a plurality of users;
said plurality of users of said Internet (28) including a plurality of individuals in a plurality of households (120);
sending a plurality of records of Internet activity that is salient (118) to an advertiser (94) to a service provider (90);
selling said plurality of records of Internet Activity that is salient (118) to said advertiser (94);
making a first payment from said service provider (90) to one of said plurality of households (120) in exchange for the right to resell said plurality of records of Internet Activity that is salient (118) to said advertiser (94);
aggregating from said plurality of households (120) said plurality of records of Internet activity (93) that is salient (118) to said advertiser (94) into a database (122);
said aggregating of said plurality of records of Internet activity (93) being performed by said service provider (90);
sending from said service provider (90) to said advertiser (94) said plurality of records of Internet activity (93) which have been aggregated that is salient (118) to said advertiser (94);
making a second payment to said service provider (90) in exchange for receiving said plurality of records of Internet activity (93) which have been aggregated from a plurality of households (120);
said second payment being made by said advertiser (94).

85. A method comprising the steps of:
accessing the Internet (28); said Internet (28) being accessed by an individual in a household (124);
generating a plurality of household Internet transactions (136);
determining that a plurality of household Internet transactions (136) each has a specific intended destination web site (144);
paying a service provider (138) in exchange for ensuring that said plurality of household Internet transactions (136) are converted into a plurality of anonymous transactions (142);
sending said plurality of anonymous transactions (142) to said intended destination web site (144); and
transacting said plurality—of anonymous transactions (142) by said intended destination web site (144).

86. A method comprising the steps of:
using a first information appliance (12); said first information appliance (12) being used by a first person (10);
connecting said first information appliance (12) to the Internet (28);
said first information appliance (12) being equipped with an Anonymizer (84); and
inspecting Internet activity (14) performed on said first information appliance (12);
said inspection being thwarted by said Anonymizer (84);
equipping said Filter (23) with a de-Anonymizer (85);
said inspection of said Internet activity (14) conducted on said first information appliance (12) being performed by a second person (18);
said Internet activity (14) inspection being enabled by installation of a Filter (23) by said second person (18);
said Filter (23) connected to a network between said first information appliance (12) and said Internet (28).

87. A method comprising the steps of:
using a first information appliance (12); said first information appliance (12) being used by a first person (10);
connecting said first information appliance (12) to the Internet (28);
said first information appliance (12) is equipped with protocol tunneling (86); and
inspecting Internet activity (14) performed on said first information appliance (12);
said inspection of said Internet activity (14) conducted on said first information appliance (12) being performed by a second person (18);
said Internet activity (14) inspection being enabled by installation of a Filter (23) by said second person (18);
said Filter (23) connected to a network between said first information appliance (12) and said Internet (28);
said Filter (23) is equipped with a protocol tunnel reader (87).

88. A method comprising the steps of:
using a first information appliance (12); said first information appliance (12) being used by a first person (10);
said first information appliance (12) receiving a protocol (88); and
controlling protocol (88) transmissions on said first information appliance (12); said controlling of said protocol (88) transmitted on said first information appliance (12) being performed by a second person (18); said second person using a second information appliance (16);
said Filter (23) connected to a network between said first information appliance (12) and said second information appliance (16);
said protocol (88) transmission control being enabled by installation of a Filter (23) by said second person (18);
said second person (18) controlling when protocol (88) can transmit to first information appliance (12).

89. A method as recited in claim 86, in which said protocol (88) is a video game (89).

90. A method comprising the steps of:
using a first information appliance (12); said first information appliance (12) being used by a first person (10);
connecting said first information appliance (12) to the Internet (28);
inspecting Internet activity (14) performed on said first information appliance (12);
said inspection of said Internet activity (14) conducted on said first information appliance (12) being performed by a second person (18);
said Internet activity (14) inspection being enabled by installation of a Filter (23) by said second person (18);
said Filter (23) connected to a network between said first information appliance (12) and said Internet (28);
equipping said Filter (23) with a by-pass method (114);
said by-pass method (114) enables an authorized Filter (23) user to disable said Internet activity (14) inspection capability.

91. A method as recited in claim 90, further comprising the step of:
equipping a first person information appliance (12) with a method (112); said method (112) enables an authorized user to disable said by-pass method (114).

92. A method comprising the steps of:
using a first information appliance (12); said first information appliance (12) being used by a first person (10);
connecting said first information appliance (12) to a network; and
inspecting network activity performed on said first information appliance (12);
said inspection of said network activity conducted on said first information appliance (12) being performed by a second person (18);
said network activity inspection being enabled by installation of a Filter (23) by said second person (18);
said installation being performed without special computer expertise (100);
said Filter (23) connected between said first information appliance (12) and said network;
said Filter (23) installation being completed and said Filter (23) showing said first person's (10) said network activity without said second person (18) having access to said first information appliance (12);
said inspection of said network activity by said second person (18) is conducted on data that has been filtered and reduced from its original version without special computer expertise (100).
said Filter (23) enables said second person (18) to establish a criterion (62) without special computer expertise (100); said criterion (62) is used to render judgment regarding the appropriateness (32) of said network activity.

93. A method as recited in claim 92, in which said computer network is a Bluetooth network.
